(19) United States
(12) Patent Application Publication
(10) Pub. No.: US 2019/0073244 A1
(43) Pub. Date: Mar. 7, 2019

(54) COMPUTER NETWORK-BASED EVENT MANAGEMENT

(71) Applicant: Vicktor Capital (Asia) Limited, Hong Kong (HK)

(72) Inventor: Ka Shun Kevin Fung, Hong Kong (HK)

(21) Appl. No.: 16/121,403

(22) Filed: Sep. 4, 2018

Related U.S. Application Data
(60) Provisional application No. 62/553,924, filed on Sep. 4, 2017.
(60) Provisional application No. 62/717,773, filed on Aug. 11, 2018.

(51) Int. Cl. G06F 9/50; H04L 12/26; H04L 12/24; G06F 11/34

(52) U.S. Cl. CPC G06F 9/5044; H04L 43/04; H04L 43/08; H04L 41/0893; G06F 9/5077; G06F 2209/5019; G06F 11/3409; H04L 43/16; G06F 2209/5011; G06F 2209/5022; H04L 41/147

(57) ABSTRACT

A host system defines an event having a pool. The event is contingent on an outcome. The host system receives event data such as a stake value, a certainty value, and content data from network entities coupled to the network. The host system may identify and exclude network entities from the event and accordingly release their bids. The host system computes an estimated allotment for each active network entity and communicates the estimated allotments to the network entities. The estimated allotment may be based on a multiplier, determined based on certainty values of the event data. The host system determines outcome data and an actual allotment for the active network entities based on the outcome data. The host system generates and communicates results data to be displayed. The host system generates a command to allot respective winnings to the appropriate network entities, by transferring winnings to a beneficiary account.

The present disclosure is directed to computer network-based event management, and more particularly, the present disclosure is directed to computer network-based methods and systems for managing an event involving stakes and settlements among network entities. This application claims the benefit of U.S. Provisional Patent Application No. 62/553,924 filed Sep. 4, 2017, and U.S. Provisional Patent Application No. 62/717,773 filed Aug. 11, 2018, the disclosures of which are hereby incorporated by reference herein in their entirety.

### BACKGROUND

Solicited competitions typically have a prize for which competitors compete with one another to win partially or fully. However, these formats typically lack an incentive system for competitors. The competitors are sometimes required to submit a deposit to be granted a stake in the competition. Determination of the winnings for each competitor is achieved via odds or other factor. The incentive to submit a submission, and how much, may be dependent upon the rules of the competition, the expected reward, the amount required to buy-in, and difficulty of the competition itself.

### SUMMARY

In some embodiments, the present disclosure is directed to managing a staking process in the content of an outcome-based event, determining potential allotments, and awarding allotments based on the outcome. In some embodiments, the present disclosure is directed to requiring competitors to submit a deposit to be granted a stake in a competition, which may act to strengthen the alignment of interest between the competitors and competition organizer(s).

In some embodiments, the present disclosure is directed to a computer network-based method. For example, the method may be performed by a host system implemented using computing equipment coupled to a network. The method includes defining, by computing equipment coupled to a network, an event including at least one pool. The event is contingent on at least one outcome. The method also includes receiving, at the computing equipment, respective event data from each of a plurality of network entities coupled to the network. Each of the respective event data includes a stake value, a certainty value, and content data associated with the at least one outcome. The method also includes identifying, by the computing equipment, a subset of network entities to exclude from the event based on at least one of a certainty value and a performance metric. The method also includes excluding the subset of network entities from the event. The remaining network entities, not included in the subset, are active network entities in the event. The method also includes computing, by the computing equipment, a respective estimated allotment for each active network entity based on the at least one pool, a respective stake value, and a respective certainty value. The method also includes communicating, over the network using the computing equipment, to each of the active network entities the respective estimated allotment. The method also includes determining, by the computing equipment, outcome data corresponding to the at least one outcome. The method also includes, in response to receiving the outcome data, computing an actual allotment to each respective active network entity based on the at least one pool, the respective stake value, respective content data, at least one multiplier, and the outcome data. The method also includes generating, using the computing equipment, results data based on the outcome data. The method also includes communicating over the network, using the computing equipment, the results data to be displayed. The method also includes generating a command, using the computing equipment, to allot the actual allotment to each respective active network entity entitled to allotment. This achieved by causing a respective beneficiary account associated with the active network entities entitled to allotment to receive the respective actual allotment.

In some embodiments, the performance metric includes at least one of a historical performance metric and a live performance metric.

In some embodiments, the performance metric includes at least one of an accuracy, a precision, an average precision, an F1 score, a logloss value, an area-under-a-curve (AUC), a recall value, mutual information, adjusted mutual information, normalized mutual information, a Rand index, an adjusted Rand index, a completeness, a Fowlkes-Mallows index, a homogeneity value, a V-measure, explained variance, mean absolute error, mean squared error, mean squared log error, median absolute error, root mean square error, and an R-squared value.

In some embodiments, causing the respective beneficiary account associated with the active network entities entitled to allotment to receive the respective actual allotment includes updating a database stored in an immutable distributed network.

In some embodiments, identifying the subset includes sorting the data from the plurality of network entities based on certainty values, determining a threshold value based on the certainty values, the at least one pool, and stake values, and identifying the subset based on the threshold value.

In some embodiments, the outcome is expected to be available at a future time, and the content data includes prediction data associated with the at least one outcome.

In some embodiments, computing the actual allotment to each respective network entity of the second subset includes comparing the respective prediction data to the outcome data, and determining the actual allotment based on the comparing.

In some embodiments, the method includes determining a current performance value based on the comparing, and determining the actual allotment is based on the current performance value.

In some embodiments, the method includes determining the multiplier based on at least one of the certainty values.

In some embodiments, the multiplier is based on a minimum certainty value of the active network entities.

In some embodiments, the actual allotments sum to a total value that is substantially equal to the at least one pool.

In some embodiments, the actual allotments sum to a total value that is less than the at least one pool by a difference. In some embodiments, the method includes allocating the difference between the total value and the at least one pool to at least one of another pool associated with at least one other event, at least one of the active network entities in addition to the actual allotment, and at least one network entity of the subset of network entities that is excluded.

In some embodiments, the network includes a plurality of nodes that form a sub-network on which an immutable database is distributed and receiving the respective event data includes updating the immutable database to reflect the respective event data. In some embodiments, updating the immutable database includes updating the immutable database to reflect a transfer of value based on the stake value.

In some embodiments, for each of the network entities, event data corresponding to all other network entities is hidden.

In some embodiments, the actual allotment includes a number of value tokens. In some embodiments, a value token of the number of value tokens is exchangeable for at least one of fiat and a cryptocurrency.

In some embodiments, the at least one multiplier includes a single value at a particular time during the event. In some embodiments, the single value changes during the event. In some embodiments, the single value is equal to an inverse of a minimum certainty value corresponding to the active network entities. In some embodiments, the at least one multiplier is equal to an inverse of a maximum certainty value corresponding to the subset of network entities that are excluded from the event.

In some embodiments, the multiplier includes more than one value at a particular time during the event.

In some embodiments, the method includes receiving at least one update to event data from a respective active network entity of the active network entities, updating the event data based on the update.

In some embodiments, in response to receiving the at least one update, the method includes computing, by the computing equipment, an updated respective estimated allotment for each active network entity based on the update, and communicating, over the network using the computing equipment, to each of the active network entities the respective updated estimated allotment.

In some embodiments, a sum of the respective estimated allotments is constrained to be less than or equal to the at least one pool.

In some embodiments, the at least one outcome includes a first outcome and a second outcome, wherein the second outcome is conditional on the first outcome.

In some embodiments, the at least one outcome includes a binary outcome.

In some embodiments, the at least one outcome includes a judgment-based outcome.

In some embodiments, the at least one outcome includes a criterion-based outcome.

In some embodiments, the method includes updating, for each respective active network entities, the performance metric based on the outcome data and the content data, and computing the actual allotment to each respective active network entity based on the performance metric and on a comparison of the outcome data to the content data.

In some embodiments, excluding the subset of network entities includes generating and communicating an indication of exclusion over the network to at least the subset of network entities. In some embodiments, communicating the indication of exclusion occurs before receiving the outcome data.

In some embodiments, the pool includes a single value at a particular time during the event.

In some embodiments, the single value changes during the event.

In some embodiments, a change in the single value is based on at least one stake value.

In some embodiments, the method includes receiving a respective indication of a transfer of value from each network entity to an account associated with the computing equipment. The value is equal to the respective stake value associated with the respective event data.

In some embodiments, excluding the subset of network entities from the event includes causing a respective beneficiary account associated with each network entity of the subset of network entities that are excluded from the event to receive a transfer of value equal to the respective stake value.

In some embodiments, the present disclosure is directed to computing equipment coupled to a network and configured to perform the aforementioned methods and techniques.

In some embodiments, the present disclosure is directed to non-transient computer readable medium that includes non-transitory computer readable instructions for performing the aforementioned methods and techniques.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a system diagram of an illustrative system for managing an event, in accordance with some embodiments of the present disclosure;

FIG. 2 shows a block diagram of an illustrative host system receiving event data, in accordance with some embodiments of the present disclosure;

FIG. 3 shows a block diagram of an illustrative host system communicating information to a network, in accordance with some embodiments of the present disclosure;

FIG. 4 shows a flowchart of an illustrative process for managing a bidding process and a settlement process associated with an event, in accordance with some embodiments of the present disclosure;

FIG. 5 shows a flowchart of an illustrative process for managing an event contingent on an outcome, in accordance with some embodiments of the present disclosure;

FIG. 6 shows a flowchart of an illustrative process for determining estimated allotments, in accordance with some embodiments of the present disclosure;

FIG. 7 shows a flowchart of an illustrative process for managing stakes, in accordance with some embodiments of the present disclosure; and

FIG. 8 shows a flowchart of an illustrative process for implementing an auction event, in accordance with some embodiments of the present disclosure.

### DETAILED DESCRIPTION

In some embodiments, the present disclosure is directed to managing staking and allotments to stakeholders in the context of an event. In some embodiments, the present disclosure is directed to managing received content data from users and determining which users' content data are successful or unsuccessful. For example, the present disclosure may be applied to such illustrative events as competitions, auctions, and solicited forecasting.

In an illustrative example, the present disclosure may be applied to a stake-based submission process associated with an event having at least one outcome, available to a plurality of users on a network. The event may be configured for bidders (e.g., the “users” in this example) to potentially win a fraction of and up to the whole sum of a prize (i.e., the “pool”). The prize may include a pool of money of a predetermined fixed amount or otherwise, an interest in a valuable item, or a token of value. Bidders submit a stake value (e.g., the amount the bidder stands to lose) with a certainty (e.g., expected odds, multiplier or payout ratio) as to whether a future outcome will occur. To illustrate, certainty may include a probability or other suitable statistical value. A higher certainty value may correspond to a lower expected multiplier (e.g., the multiplier may be equal to 1/certainty). The stake value (e.g., a bid amount) may be cast in any suitable units such as, for example, virtual points, credits, real currencies, cryptocurrencies, real assets, virtual assets, any other suitable unit, or any combination thereof.

The subject of an event may include, for example, an economic occurrence (e.g., a share price or other metric at a particular time), a social occurrence (e.g., an approval rating of a policy), a political occurrence (e.g., an election or appointment), an auction, a solicited answer to a question, a competition, or any other suitable occurrence having an associated potential outcome. To illustrate, the subject of an event may include a determination of the share price of a listed corporation at a future date. Based on historical and current data that may be available, a prediction may be generated as to the share price. The ability to accurately generate predictions may have economic value. Accordingly, an incentive to generate an accurate prediction, or a succession of accurate predictions, may be provided as a motivator to prediction-generating entities (e.g., users).

Outcomes associated with events may include, for example, judgment-based outcomes, criterion-based outcomes, any other suitable outcomes, or any combination thereof. For example, an event may include a competition to predict future results based on a predictive model, and the prediction may be compared to the outcome to determine settlements. In a further example, an event may include a competition to provide the most elegant solution to a problem (e.g., a mathematical problem or financial problem), and the solutions may be evaluated by judges to determine a settlement. In a further example, an event may include a competition to provide the most relevant content in the context of a topic, and the solutions may be compared with one another by judges to determine a settlement. In a further example, an event may include a competition to provide a prediction using the least or fewest computing resources, and the solutions may be compared with one another or with a threshold to determine a settlement.

In some embodiments, as a user (e.g., a participant) participates in more events, statistical metrics of the user's performance may be determined. For example, a user that typically makes accurate predictions may be differentiated from a user that does not. In a further example, a user that typically makes accurate predictions with a higher confidence may be differentiated from a user that makes accurate predictions with a lower confidence. Ranking is a technique to sort users based on performance. In some embodiments, a higher ranking corresponds to better performance. A ranking may be generated in the context of a single event, a group of successive events, a period of time, or any combination thereof. Ranking is usually performed in descending order, with the best-ranked entity corresponding to a lower ranking index (e.g., number one rank is the best, and number two is second-best).

In an illustrative example, in the context of finance, new and high-quality financial data may be provided weekly to coincide with the start of a weekly competition to predict the data. Data scientists, for example, participate in the competition by submitting prediction data (e.g., before the outcome is known) and receiving rewards of value tokens if their predictions are successful (e.g., as determined after the outcome is available). The ranking of the data scientists need not be based only on the accuracy of their predictions. Correlations between predictions from different participants may also be taken into consideration. For example, if participant A and participant B use similar machine learning methods to generate their predictions, their prediction data may have a high correlation to each other. If participant A submits first and participant B submits second, participant B may be punished as “No Rank” even if their associated logloss and/or area-under-the-curve (AUC) is slightly better than that of participant A. In some embodiments, “No Rank” participants are not eligible for final ranking and reward (e.g., they are excluded from the event). In some embodiments, only participants whose predictions perform better based on logloss (e.g., less than −ln(0.5)) for the whole test dataset will earn the qualification to join the final ranks (e.g., be active participants). In some embodiments, final ranks and earnings are published publicly (e.g., displayed on a website) after the outcome (e.g., the live data subset) is available. For some financial data, for example, this may be about four weeks after the competition starts. Winners are rewarded through value tokens according to an allotment schedule (e.g., a settlement). Table 1, shown below, illustrates a schedule (e.g., that may be subject to change upon a future announcement).

An event may have an associated outcome that is expected to be known, available, or revealed at a future time (e.g., after staking). Content data may include, for example, a numerical value, an alphanumeric value, a selection (e.g., a person, place, or thing), a state value (e.g., up or down in the context of a value

TABLE 1
Illustrative allotment schedule.

| Final | |
|---|---|
| Rank | Payout |
| 1 | 30.0000 |
| 2 | 24.0000 |
| 3 | 19.2000 |
| 4 | 15.3600 |
| 5 | 12.2880 |
| 6 | 9.8304 |
| 7 | 7.8643 |
| 8 | 6.2914 |
| 9 | 5.0331 |
| 10 | 4.0265 |
| 11 | 3.2212 |
| 12 | 2.5770 |
| 13 | 2.0616 |
| 14 | 1.6493 |
| 15 | 1.3195 |
| 16 | 1.0556 |
| 17 | 0.8445 |
| 18 | 0.6756 |
| 19 | 0.5405 |
| 20 | 0.4324 |
| 21 | 0.3459 |
| 22 | 0.2767 |
| 23 | 0.2213 |
| 24 | 0.1770 |
| 25 | 0.1416 |
| 26 | 0.1133 |
| 27 | 0.0907 |
| 28 | 0.0726 |
| 29 | 0.0581 |
| 30 | 0.0465 |
| 31 | 0.0372 |
| 32 | 0.0298 |
| 33 | 0.0239 |
| 34 | 0.0192 |
| 35 | 0.0154 |
| 36 | 0.0124 |
| 37 | 0.0100 |
| 38 | 0.0081 |
| 39 | 0.0066 |
| 40 | 0.0054 |
| 41 | 0.0044 |
| 42 | 0.0036 |
| 43 | 0.0029 |
| 44 | 0.0023 |
| 45 | 0.0018 |
| 46 | 0.0014 |
| 47 | 0.0011 |
| 48 | 0.0009 |
| 49 | 0.0007 |
| 50 | 0.0005 |
| TOTAL | 150.0022 |

that can change over time), a binary value (e.g., yes/no, true/false, more/less), one or more results from a model, a model itself (e.g., that can be executed to determine a result), a file (e.g., an image, a video, text, or computer code), any other suitable content, or any combination thereof.

In the context of prediction-based events, a prediction of an outcome may be generated by users based on, for example, mathematical models (e.g., deterministic, probabilistic, or otherwise), historical data, current data, or a combination thereof. Users may employ any suitable predictive analytics to generate a prediction. The prediction is made without knowledge of the outcome, although the prediction may be made based on historical information. For example, a predictive model may be tuned, calibrated, or trained based on a historical data set. Typically, when generating a model, a user may consider a training data set, and a test data set. For example, the model may be trained based on the training data set and may be evaluated based on its ability to predict outcomes in the test data set. In a further example, a user may determine a certainty value based on the evaluation of the model.

Participants submit content data in the context of an event. For example, a host system may communicate the existence of the event, the amount of the pool, the criteria for winning, a minimum or maximum stake amount, any other suitable information, or any combination thereof to network entities (e.g., via the network). For example, the host system may have an associated website that displays event information.

In some embodiments, a call for stakes (e.g., bids) may accompany an event. For example, in connection with the event (e.g., to win the prize), a plurality of users may submit event data (e.g., stake values, certainty values, and content data) via a computer network to a hosting application. The hosting application may receive the event data and perform matching. Matching is the determination of estimated allotments based on the stakes.

In some embodiments, matching may include determining a multiplier by which a stake is multiplied to generate an estimated allotment. The multipliers for each stake may be the same or different from one another. For example, in some embodiments, a single multiplier is determined, by which all active stakes are multiplied. In a further example, a multiplier is determined using an iterative process to determine a single, desired multiplier value.

In some embodiments, after an estimated allotment is determined, the estimated allotments are made public, or otherwise communicated to at least some of the participants. In response to receiving the estimated allotments, the participants may be given an opportunity to adjust their event data. For example, if the multiplier is larger than they were expecting, some participants may decide to increase their stake value. In a further example, participants having a lower-than-expected estimated allotment, or no allotment, may decide to increase their certainty value. The process of receiving stakes, estimating/communicating allotments, and receiving updated event data may continue for any suitable period of time (e.g., an open-staking period) or any suitable number of rounds (e.g., a predetermined number of updating rounds). In some embodiments, only a single round is allowed (e.g., event data is submitted once, and is not allowed to be updated). In some embodiments, many rounds are allowed (e.g., event data is submitted repeatedly until each participant desires no further updates). In some embodiments, the estimated allotments are kept private by the host system, or otherwise hidden, from all participants until the open-staking period has ended.

If and when the outcome associated with the event is available, the event may be settled (e.g., a settlement may be determined). For example, the host system may receive outcome data and subsequently evaluate the prediction data of the active users. The outcome data may be received from a user (e.g., not a user participating in the event), a reporting source (e.g., a broadcast report or other public disclosure), or any other suitable information source. In some embodiments, wherein the outcome is a conditional outcome, outcome data includes data for each outcome, such that a settlement may be generated. For example, if an event is associated with the outcome of B that depends on outcome A, then outcome data for both, or just outcome B, may be required. In a further example, if an event is associated with the outcome of B and the outcome of A (e.g., an “and,” “or,” or “if-then” outcome conditionality), then outcome data for both may be required for settlement. Settlement may be dependent on outcome data for one outcome, two outcomes, or more than two outcomes.

In some embodiments, the host system may define at least one event, and may define more than one event in some circumstances. In some embodiments, an event may have one or more associated outcomes. In an illustrative example, an event may include participants staking predictions on respective outcomes that will be available at a later time. For example, Participant 1 may stake that Company A outperform Company B from tomorrow for a week. Participant 2 may stake that a share price of Corporation D outperforms an index of a stock market from tomorrow for a year. Participant 3 may stake that Company E outperforms Company F from tomorrow for 3 months. If these content data were associated with a single event, the outcome and settlement might correspond to the longest wait time (e.g., the event is settled when all relevant outcome data are received and/or available). Accordingly, an event may be contingent on one or more outcomes each having different time scales.

Events have an associated pool. The pool may include, for example, a fixed amount of value tokens (e.g., which may include a cryptocurrency or symbolic token having an exchange rate). In some embodiments, participants are allowed to submit stakes after submitting content data to the host system. When the competition ends (e.g., when staking is closed), no further participants are allowed to submit or update stakes. Invalid stakes may be refunded to the corresponding participant according to an auction mechanism. Valid bids may be locked until the outcome is determined. For example, to illustrate live results may be available after three weeks, or other future time. After the outcome data is known, the prize pool is allocated among participants.

In an illustrative example, the event may include an auction for a pool, based on prediction results for a future outcome. The host system may attempt to determine a single auction price (e.g., a single multiplier) for all potential winning bidders before the future outcome is determined. Once the competition is closed to bidding (e.g., all the bids are submitted), the prize pool is estimated to be allocated to the participants sorted from the highest certainty value on down (e.g., or the lowest 1/certainty value on up), until the prize pool is depleted. However, the potential payout that each bidder gets is based on the highest 1/certainty value of all the active bidders, or essentially the last valid bid. To illustrate, if a participant bid 100 value tokens (i.e., the stake) with a 1/certainty value of 1.7, and if the last valid bid of the sorted bids is 2.7, the participant stands to get a reward of at least 270 value tokens (i.e., 100 multiplied by 2.7). Shown below in Table 2 is an illustrative example of the estimated allotments with a prize pool of 3,000 value tokens.

TABLE 2
Estimated allotments based on a multiplier.

| | | | | | Cumulative |
|---|---|---|---|---|---|
| | | | 1/Certainty | Estimated | Estimated |
| Rank | Bid size | 1/Certainty | for reward | Allotment | Allotment |
| 1 | 100 | 1.1 | 2.7 | 270 | 270 |
| 2 | 40 | 1.2 | 2.7 | 108 | 378 |
| 3 | 70 | 1.4 | 2.7 | 189 | 567 |
| 4 | 100 | 1.7 | 2.7 | 270 | 837 |
| 5 | 140 | 2.0 | 2.7 | 378 | 1,215 |
| 6 | 170 | 2.2 | 2.7 | 459 | 1,674 |
| 7 | 200 | 2.4 | 2.7 | 540 | 2,214 |
| 8 | 80 | 2.5 | 2.7 | 216 | 2,430 |
| 9 | 120 | 2.7 | 2.7 | 324 | 2,754 |
| 10 | 100 | 2.7 | 2.7 | 270 | 3,024 |

| | | | |
|---|---|---|---|
| 11 | 300 | 3.9 | Invalid Bid |
| 12 | 100 | 4.1 | Invalid Bid |
| 13 | 200 | 4.3 | Invalid Bid |

In some embodiments, the estimated allotments are determined based on iteration. For example, referencing Table 2, the bids are ranked by the inverse of their certainty value. Therefore, the host system, starting from the highest certainty value on the top of the table (i.e., index 1), allots an accumulated earning of 100×1.1=110 value tokens, which is less than the prize pool of 3,000 value tokens. Accordingly, for the second iteration, the host system considers the two top-ranked bidders, having a total bid size of 100+40=140 value tokens. The largest 1/certainty value is then 1.2, resulting in an accumulated earning of 140×1.2=168 value tokens (i.e., 120 value tokens to participant 1, and 48 value tokens to participant 2), which is still less than the prize pool of 3,000 value tokens. The third iteration results in an accumulated earning of 210×1.4=294 value tokens, which is still less than the prize pool of 3,000 value tokens. In some embodiments, the iterations continue until Rank 10 is considered, which results in a reward 1/certainty value of 2.7 and an accumulated earning of 1,120×2.7=3,024 value tokens (e.g., just larger than the prize pool). The multiplier 2.7 is then the universal 1/certainty value used to determine allotments. Note that in this example, the tenth bidder is entitled to an estimated 3,000−2,754=246 value tokens (e.g., if all ten bidders are entitled to a reward). For example, if all ten bidders have better live performance than random, participant 10 receives only 246 value tokens, which is less than the 270 value tokens he deserves based on the multiplier. This is because there are only 3,000 value tokens in the prize pool, and higher-ranked participants are allotted first in this example. In some circumstances, if two bidders submit event data having the same certainty value (e.g., Rank 9 and 10 in Table 2), the participant that submits first will get priority in the ranking. Referencing Table 2 for this example, bidder 11 and beyond (e.g., participants 12 and 13 too) are excluded from the auction because their certainty value is not high enough (e.g., the pool is exhausted before they would get an allotment). In some embodiments, bidders 11-13 are then freed from the auction and their bid size would be refunded (e.g., be available to stake on another event).

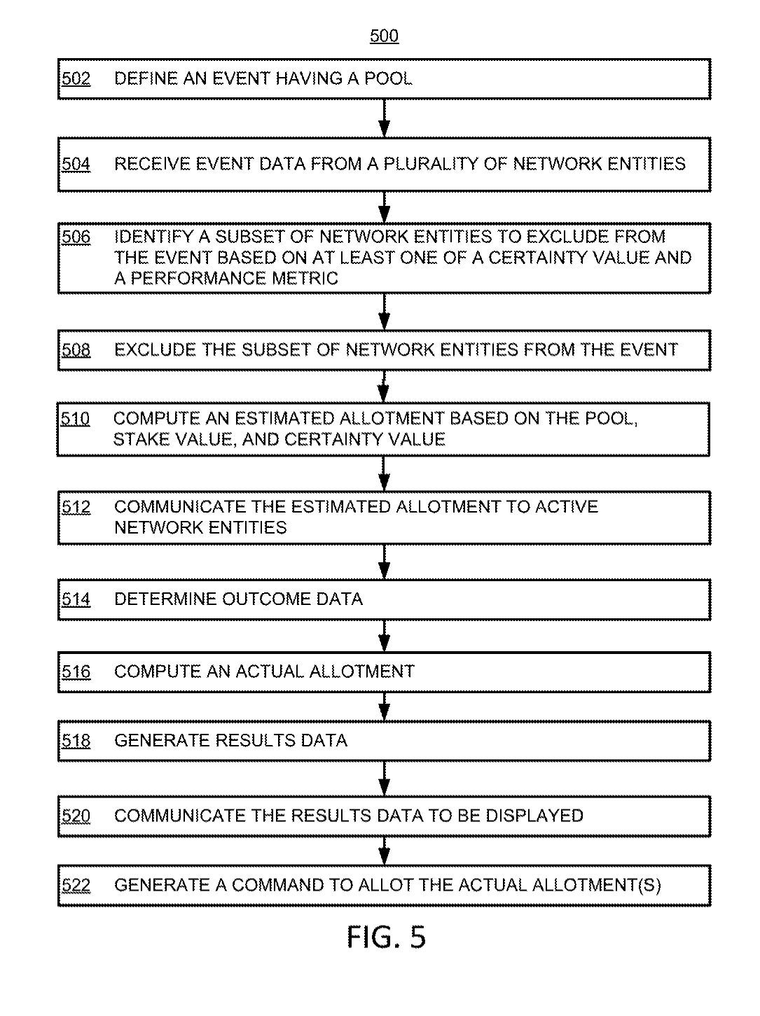

In a further illustrative example, an event may include a stock investing question-and-answer (Q&A) outcome. A question may be posed by a buyer (e.g., via the host system) such as “What is the difference between Company M and Company N?”, and a bounty of 3 value tokens is specified by the buyer. Participants may then submit bids to the auction to provide the answer. Among the bidders, if their certainty value is high enough (e.g., above a threshold or in the top portion of sorted certainty values), then they may be qualified and are allowed to provide an answer. Otherwise, if their certainty value is too low, they are not allowed to provide an answer (e.g., excluded from the event). In some circumstances, the buyer may specify one or more rules. For example, the buyer may stipulate that up to three answers will be accepted. In a further example, the buyer may specify the number of words expected in the answer, or other aspect the answer. In a further example, the buyer may accept bids up to the total estimated allotment of three value tokens. In a further example, the buyer may stipulate a minimum stake value, a maximum certainty, or both. In some embodiments, the host system need not wait until the end of open-staking to select active participants. For example, if a participant submits the maximum certainty, the estimated allotment of the bounty of three value tokens may be transferred to the participant and they may then submit an answer. In effect, there would be demand, supply, and a price point for the Q&A type outcome. In some embodiments, the host system may allow the buyer to complain (e.g., from dissatisfaction with the answer), the participant to dispute the buyer's complaint, and a judge or mediator to rule as to the complaint. In some embodiments, if a participant submitting an answer submits an unsuccessful answer (e.g., the answer is irrelevant, not useful, or otherwise unsatisfactory), then the participant's stake may be lost (e.g., the host system keeps or otherwise does not return the stake to the participant). In some embodiments, participants submit a stake value and certainty first (e.g., submit a deposit of value tokens), before submitting content data. Then, if the host system determines that their stake is valid, the participant may submit content data. If the host system determined that the stake is invalid, the host system may optionally return the stake, and exclude the participant from the event. For example, FIG. 5 shows an example of a participant submitting a stake value, certainty value, and content data before the host system determines the active network entities and the excluded network entities.

Upon availability of the outcome (e.g., determination of outcome data), the host system may then proceed to determine a settlement. The settlement for each participant depends on the pool (e.g., the total prize available), the multiplier (e.g., to determine allotment from stake), the content data, and the outcome data. Some of the active participants may have favorable/successful content data, while some active participants may have unfavorable/unsuccessful content data. Accordingly, the settlement (e.g., the set of actual allotments) may include allotments that are greater than, less than, or equal to the estimated allotment. For example, participants having unsuccessful content data may lose their stake value and receive no allotment. In a further example, participants having successful content data may receive the estimated allotment. In a further example, participants have successful content data and a sufficient performance metric may receive their estimated allotment and an additional allotment (e.g., a higher effective multiplier). In some embodiments, the settlement is the distribution of the pool among participants. In some circumstances, the settlement may be less than the pool. For example, if the entire pool is not allotted, then the excess (e.g., the difference) may be applied to a pool in another event, distributed among active participants, distributed among excluded participants, applied toward overhead (e.g., operating costs) of the host system, or a combination thereof.

TABLE 3
Illustrative settlement for an event.

| | | 1/Certainty | Performance | | Cumulative |
|---|---|---|---|---|---|
| Rank | Bid size | for reward | metric (logloss) | Allotment | Allotment |
| 1 | 100 | 2.7 | 0.690293 | 351.0 | 351.0 |
| 2 | 40 | 2.7 | 0.693440 | Unsuccessful Bid | |
| 3 | 70 | 2.7 | 0.691081 | 207.9 | 558.9 |
| 4 | 100 | 2.7 | 0.691467 | 297.0 | 855.9 |
| 5 | 140 | 2.7 | 0.691218 | 415.8 | 1,271.7 |
| 6 | 170 | 2.7 | 0.693174 | Unsuccessful Bid | |
| 7 | 200 | 2.7 | 0.695133 | Unsuccessful Bid | |
| 8 | 80 | 2.7 | 0.691761 | 216.0 | 1,487.7 |
| 9 | 120 | 2.7 | 0.691574 | 324.0 | 1,811.7 |
| 10 | 100 | 2.7 | 0.691933 | 270.0 | 2,081.7 |

In some embodiments, upon availability of an outcome, participants achieving a performance metric above a threshold (e.g., a logloss value less than −ln(0.5)) are eligible for an allotment. In an illustrative example, a settlement may be as follows:
The top 10% successful bidders get 1.3× rewards
The next 40% successful bidders get 1.1× rewards.
The remaining successful bidders get 1.0× rewards.
Unsuccessful bidders get no rewards, and their stakes are destroyed.
Bidders achieving a logloss greater than −ln(0.5) but less than 0.693300, have only half of their stake (e.g., staked value tokens) destroyed.
All tokens of the other unsuccessful bidders are destroyed.

Table 3 illustrates how an auction mechanism may works when live results come out (e.g., the outcome data is available).

Referencing Table 3, bidder 1 gets 1.3× rewards as they are the only participant winning the top 10% places of all the successful bidders (7 successful bidders in total in the example). Bidders 2 and 7 have worse performance than required (e.g., unsuccessful content data), thus they do not receive any rewards, and all their bidding value tokens are destroyed for good. Bidder 6 gets only 85 value tokens destroyed instead of 170, because their logloss is greater than +ln(0.5) but less than 0.693300. All other winners are rewarded with actual allotments strictly according to the payout schedule.

In some embodiments, an auction mechanism may generally follow the following illustrative process:
1. Participants train their models, and submit content data (e.g., predictions) to the host system.
2. Participants place bids on their own content data.
3. Host system determines the universal bid price (i.e. the universal 1/certainty value) every time a new bid is placed.
4. The universal bid price may be fixed when competition ends.
5. Invalid bids are refunded, and valid bids are locked.
6. Successful participants achieving a better live logloss are rewarded, while value tokens of the other participants may be destroyed.

In some embodiments, the host system manages allotment of alternative prizes for eligible value token holders to claim prizes based on the amount of value tokens they hold (e.g., how successful they have been in events). In some embodiments, the host system conducts the event as described herein, with a target pool with a fixed amount of value tokens set up every time the event starts. The host system then determines the winning bidders. In some embodiments, a participant having value tokens submits a bid using a blockchain (e.g., using smart contracts and for which the distributed ledger stores the transaction). The bids may be encrypted (e.g., hidden from other participants) and updated on the blockchain until the end of the open-staking period. The host system may optionally cause bidding records, matching records (e.g., one or more estimated allotments), and settlements (e.g., one or more actual allotments) to be stored on the blockchain. In some embodiments, for example, the bids are decrypted (e.g., made publicly available) after the end of the staking period. In some embodiments, all of the bids are published (e.g., made publicly available) and any participant can retrieve event information. When bidding ends and all bids are submitted, the prize is assigned to the bidders from the lowest bids up, until all the value tokens of the pool are allotted. However, the price that each bidder gets is based on the highest bidding price of all the allotted bidders, or essentially the last valid bid. For example, if a participant bids for 10 value tokens of type A with 1,000 value tokens of type B (i.e., a bid price of 0.01 A per B), and if the last valid bid is 0.02 A per B, then the participant will have the rights to claim 20 value tokens of type A with their stake of 1,000 value tokens of type B transferred to the host system.

Table 4 shows an illustrative example of the settlement with a target fund of 20 value tokens of type A. Referencing Table 4, the settlement price will be 0.02 A per B. However, the third value token holder can receive only a small part of their bidding amount because the target pool has been depleted, and all the holders below (e.g., higher bidding price) would receive nothing. In some embodiments, once the settlement price is determined, the host system may allot the target fund (e.g., the pool) to eligible type B value token holders. In some such embodiments, a target pool with a fixed amount of value tokens of type A as well as a fixed bid price are set up every time the event starts. When the event ends, all of the participants receive the fund accordingly. If an oversubscription

TABLE 4
Settlement based on two types of value tokens.

| | Amount | Bidding Price (A | | B tokens | A tokens |
|---|---|---|---|---|---|
| Holders | (type B) | per B) | Success? | Sent | Received |
| 1 | 500 | 0.005 | Yes | 500 | 10 |
| 2 | 300 | 0.01 | Yes | 300 | 6 |
| 3 | 700 | 0.02 | Partial | 200 | 4 |
| 4 | 400 | 0.04 | No | 0 | 0 |
| 5 | 200 | 0.1 | No | 0 | 0 |
| 6 | 800 | 0.6 | No | 0 | 0 |
| 7 | 1,000 | 1 | No | 0 | 0 |

occurs, participants may be able to claim type A value tokens on a pro rata basis. Table 5, below, shows an illustrative example having a target fund of 20 type A value tokens and a fixed price of 0.02 A per B.

TABLE 5
Settlement based on bids and a fixed price between value tokens.

| Holders | Initial Amount (B) | B Sent | B Left | A Received |
|---|---|---|---|---|
| 1 | 1,200 | 240 | 960 | 4.8 |
| 2 | 500 | 100 | 400 | 2.0 |
| 3 | 1,500 | 300 | 1,200 | 6.0 |
| 4 | 1,800 | 360 | 1,440 | 7.2 |

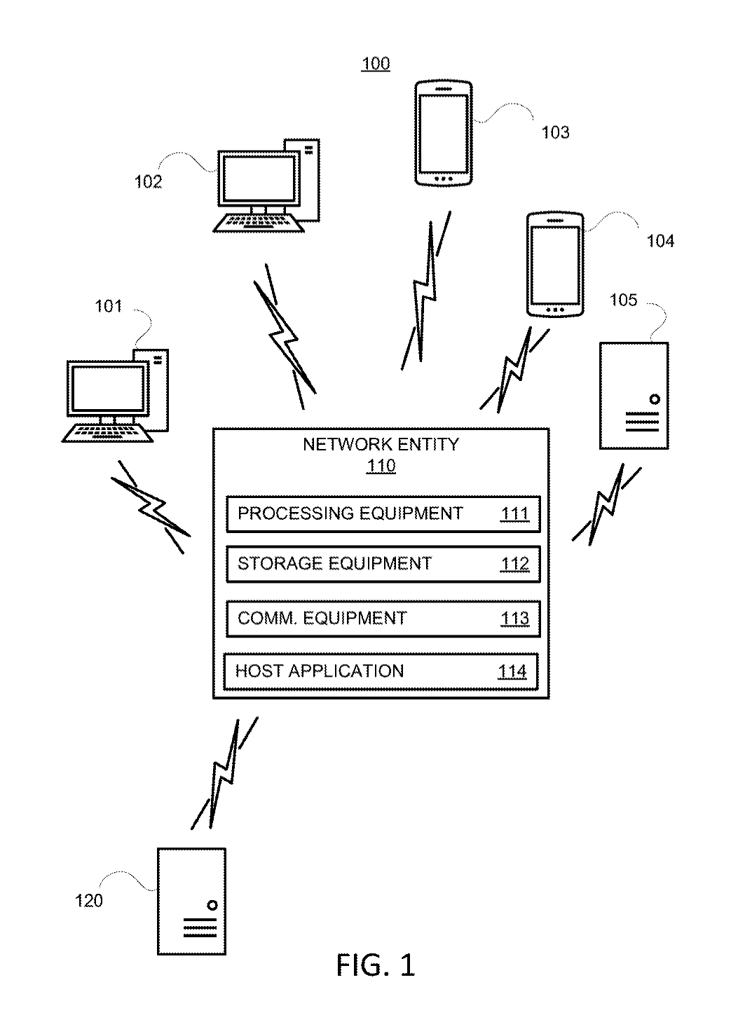

FIG. 1 shows a system diagram of illustrative system 100 for managing an event, in accordance with some embodiments of the present disclosure. System 100 includes network entity 110 that includes respective computing equipment (e.g., configured to at least partially implement a host application 114). In some embodiments, system 100 includes a host system, which may include any suitable hardware, software (e.g., host application 114), or both configured to implement the features described in the present disclosure with respect to at least generating, coordinating, and settling an event. The host system may be distributed across one or more computers, across one or more networks, and across one or more platforms. For example, as illustrate in FIG. 1, network entity 110 may be configured as a host system. Network entities 101, 102, 103, 104, 105, 110 and 120 each include respective computing equipment and are coupled to each other by a network. Network entity 110 may include computing equipment that includes, for example, processing equipment 111, storage equipment 112, communications (comm) equipment 113, any other suitable computing equipment, or any combination thereof. Processing equipment 111 may include one or more computer processors, data buses, any other suitable electronic components for processing data, or any combination thereof. Storage equipment 112 may include random-access memory (RAM), read-only memory (ROM), solid state drives, mechanical hard drives, cloud storage (e.g., remote storage), any other suitable components for storing data, or combination thereof. Communications equipment 113 may include equipment for wired communication (e.g., an RJ-45 connection port and network card), wireless (e.g., a WiFi transceiver), optical communication (e.g., a fiber optic interface card), any other suitable equipment for communicating with a network, or any combination thereof. For example, host application 114 may be implemented by processing equipment 111, storage equipment 112, and communications equipment 113. For example, processing equipment 111 may be configured to generate smart contracts (e.g., which may be stored in storage equipment 112). In a further example, all of network entities 101-105 concert may include respective storage equipment, which may store a distributed ledger (e.g., and optionally may store the distributed ledger along with storage equipment 112). The computing equipment associated with network entity 110 may be configured to achieve any of the processing functions, storage functions, communications functions, or a combination thereof, of a distributed ledger (e.g., associated with a blockchain). In some embodiments, the host application need not be associated with a single instance of computing equipment (e.g., of network entity 110), and may itself be distributed among computing equipment of network entities 101-105 or other suitable network entities. Network entities 101-105 may be associated with a computer, a laptop computer, a tablet computer, an embedded computing system, a server, a mobile device (e.g., a smartphone), an application implemented on any suitable computing equipment, any other suitable device coupled to the network, or any combination thereof.

In some embodiments, each of network entities 101-105 is associated with a respective user. For example, a user may include a research group (e.g., one or more data scientists), an investment group, a student, a gambler, or any other suitable user who may submit a stake for an event to win at least a portion of a pool. In a further example, a user may include an artificial intelligence entity, implemented in software, hardware, or both. In some embodiments, network entity 110 is configured to host an application that manages events and settlements thereof. In some embodiments, network entity 110 is associated with a company, corporation, individual, organization, any other suitable entity, or any combination thereof, that creates and proctors events, solicits submissions of stakes, and distributes allotments based on a settlement.

Network entities may communicate among one another (e.g., transmit and receive information) via the network. For example, the network may include the Internet, a sub-net, a local network, any other suitable network, or any combination thereof. For example, network entity 110 may have, using the computing equipment, an associated website and/or filesite (e.g., having a uniform resource locator (URL)), applications programming interface, an Internet protocol (IP) address, a hardware address, an electronic mail (email) address, any other suitable feature to aid in network communication, or any combination thereof.

In some embodiments, network entity 120 is associated with computing equipment configured to provide outcome data to network entity 110. For example, network entity 110 may be a data repository, a reporting entity, a file server, computing equipment associated with an individual or organization empowered to provide outcome data, any other suitable entity, or any combination thereof. In some embodiments, network entity 120 need not be included in the network. For example, in some embodiments, network entity 110 determines outcome data itself, without input from network entity 120.

In some embodiments, host application 114 may include, or communicate with, a decentralized platform that manages smart contracts (e.g., Ethereum™ or another platform that runs as programmed without significant possibility of downtime, fraud, DDoS attack or third-party interference). The host application may use tokens (e.g., ERC20™ in the context of Ethereum™) that can be transferred, or otherwise exchanged, for other tokens, currency, or valuable interest. In some embodiments, a standard smart contract, having standard application programming interfaces (APIs), may be used. A contract using such a standard is automatically compatible with any digital wallet or other contract also using the standard.

In an illustrative example, an illustrative token referred to, herein, as an APB token may be used as a stake value and an actual allotment. The APB token may be compatible with other tokens, real currency, cryptocurrency, or any other suitable real value, virtual value, or combination thereof. APB smart contracts may be used to account for, transfer, or otherwise interact with APB tokens. In the illustrative example, APB tokens are allotted to active users who are entitled to an allotment. Further, users who are confident of their predictions may send APB tokens to the host system (e.g., as registered on a blockchain) and place bids on their models to accurately predict outcomes to win more rewards.

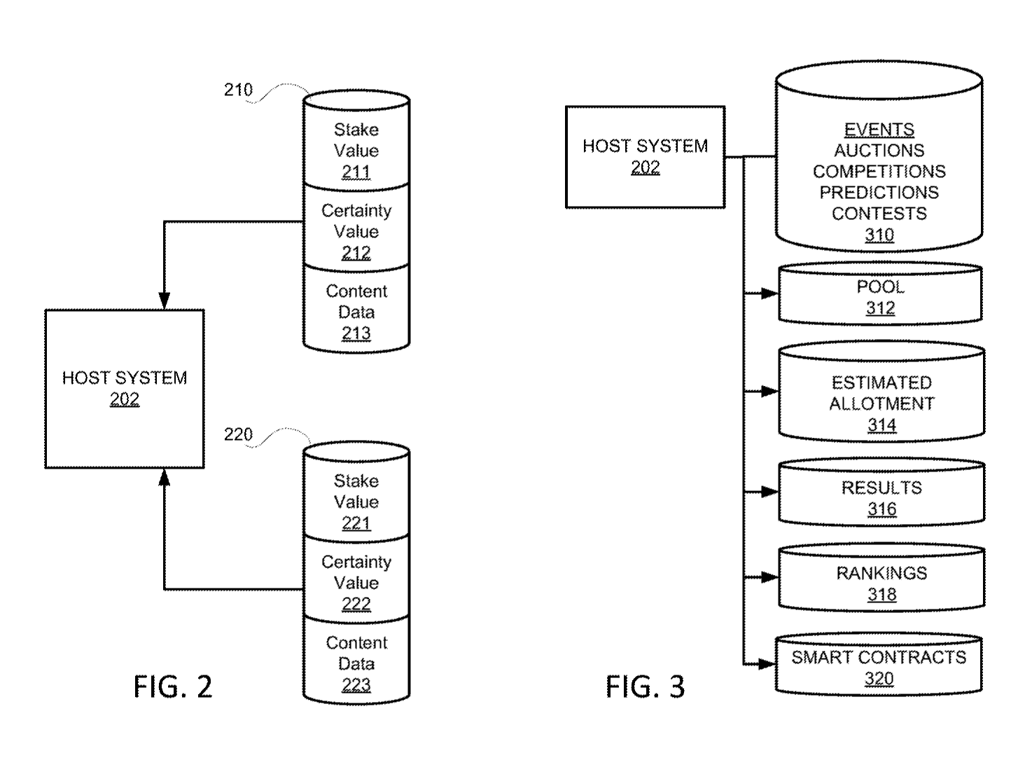

FIG. 2 shows a block diagram of illustrative host system 202 receiving event data, in accordance with some embodiments of the present disclosure. FIG. 3 shows a block diagram of illustrative host system 202 communicating information to a network, in accordance with some embodiments of the present disclosure. Host system 202 is configured to receive and transmit information with network entities using a network.

Referencing FIG. 2, host system 202 may be configured to receive event data 210 and 220 from respective network entities. Event data 210 may include stake value 211, certainty value 212, and content data 213. Event data 220 may include stake value 221, certainty value 222, and content data 223. In some embodiments, host system 202 receives event data from more than two network entities.

Referencing FIG. 3, in some embodiments, host system 202 may be configured to define event 310 and communicate (e.g., make public, or specifically communicate to an entity) information associated with event 310 to network entities. In some embodiments, host system 202 may be configured to communicate pool amount 312 to network entities. In some embodiments, host system 202 may be configured to communicate one or more estimated allotments 314 to one or more network entities. In some embodiments, host system 202 may be configured to communicate results data 316 to network entities. For example, results data 316 may include success/failure information, a performance metric, outcome data, content data, a comparison of outcome data and content data, any other suitable information, or any combination thereof. In some embodiments, host system 202 may be configured to communicate rankings 318 to network entities. For example, host system 202 may communicate a ranking for one event, a ranking for a group of events, a ranking for a succession of historical events, or an overall ranking. In some embodiments, host system 202 may be configured to communicate smart contracts 320 to one or more network nodes configured to store and add to an immutable database (e.g., a blockchain). For example, the network nodes may, but need not, include network entities submitting event data.

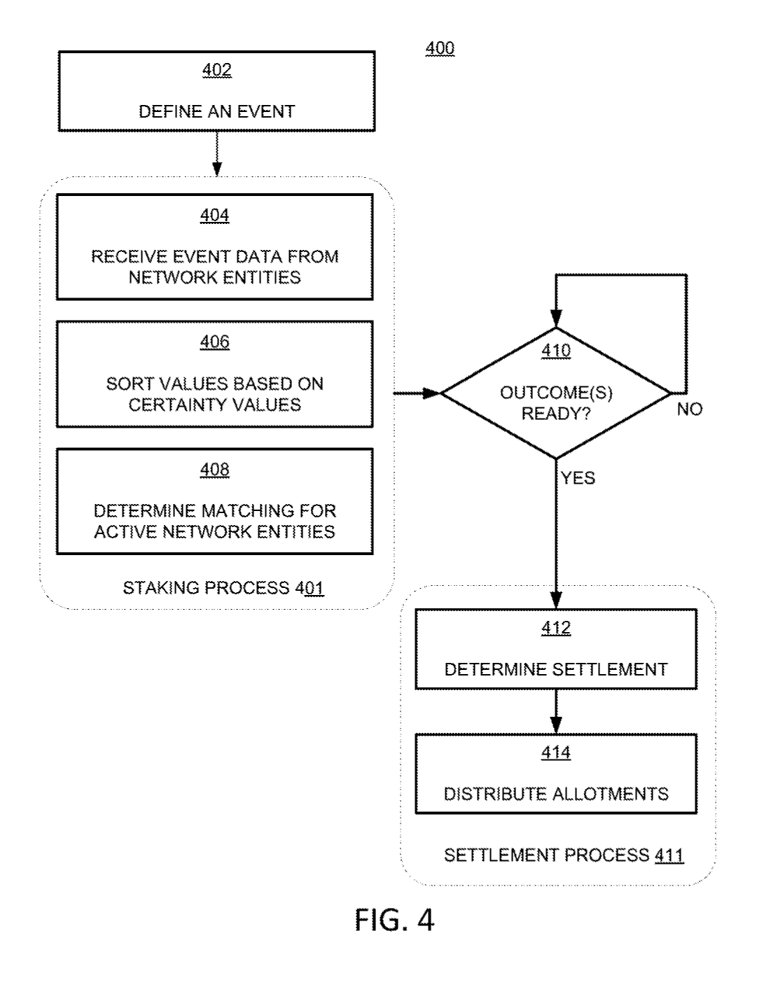

FIGS. 4-8 show illustrative processes for managing an event. The illustrative processes of FIGS. 4-8 may be implemented using any of the systems, components, and constructs of FIGS. 1-3, along with any other suitable systems. Further, any of the illustrative processes and steps thereof described in the context of FIGS. 4-8 may be combined, split into distinct steps, omitted, rearranged, or otherwise modified in accordance with the present disclosure.

FIG. 4 shows a flowchart of illustrative process 400 for managing staking process 401 and settlement process 411 associated with an event, in accordance with some embodiments of the present disclosure. The illustrative steps of process 400 are primarily partitioned into two processes, staking process 401 and settlement process 411. Staking process 401 includes the host system receiving submitted event data from participants and determining matching for the event. Settle process 411 includes the host system determining and distributing actual allotments to network entities associated with successful content data.

Step 402 includes the host system defining an event contingent on an outcome. Defining an event may include, for example, specifying what type of outcome(s) are possible, the expected latency for the outcome (e.g., outcome available next week, available in a year, or unknown), which network entities (e.g., participants) are eligible, what event data is required (e.g., minimum stake, minimum certainty, type of content data), a prize pool, rules and guidelines for the event proceedings, previous results or rankings, any other suitable aspect of an event, or any combination thereof. In some embodiments, step 402 may include a host system communicating, displaying, or otherwise making available to potential network entities, information associated with the event.

In some embodiments, network entities must submit their associated stake value as a transfer of value tokens. In some embodiments, specification of the stake value is sufficient and value tokens need not be transferred at that time. For example, the transfer of the stake value may be governed by a smart contract generated by the host system. In some embodiments, a portion of the specified stake value is required to be deposited by transferring value tokens.

Step 404 includes the host system receiving event data from a plurality of network entities. The event data may include, for example, a stake value, a certainty value, content data, network entity information (e.g., an identifier, beneficiary account information, a description of the network entity), security information (e.g., an encryption key, password, or other security safeguard), any other suitable data or information, or any combination thereof. In some embodiments, network entities communicate their respective event data to the host system via the network. For example, the host system may have an associated website, to which network entities may submit the event data. In a further example, network entities may transmit the event data to a port at a network address of the host system configured to receive event data. In some embodiments, the host system may provide a predetermined time period for accepting event data. For example, the host system may prescribe a cutoff time, by which all event data that will be considered for the event must be received. In some embodiments, the host system may require all of a predetermined number of event data submissions to be received before closing the submission process. For example, the host system may receive and accept the first twenty submissions of event data from network entities.

Step 406 includes the host system sorting the event data based on the certainty values. After the event data to be considered is received, the host system may then tabulate, sort, or otherwise arrange the event data. Arrangement of the event data allows the host system to make determinations, as well as proceed to making allotment estimates. In some embodiments, the host system sorts the event data by certainty values, in descending order. For example, number one is associated with the highest certainty. In some embodiments, the host system determines a certainty metric (e.g., inverse of certainty, other operation applied to the certainty), and sorts the event data based on the certainty metric. For example, the host system may first determine the inverse of each certainty value, and then sort the event data by inverse certainty (e.g., in ascending order). In some embodiments, the host system may store the event data in a data structure configured to allow sorting operations.

In some embodiments, the host system may use the sorted event data to determine active participants and participants to be excluded. For example, in some embodiments, participants having certainty values below a threshold may be excluded. In a further example, participants having stake values less than a threshold value may be excluded. In some embodiments, step 406 may be combined with step 408, described below, to determine active participants.

Step 408 includes the host system determining matching for the active network entities. Matching is the determination of potential winnings (e.g., estimated allotments) for the participants. In some embodiments, the host system determines a multiplier for each network entity, for multiplying the corresponding stake value to determine the estimated allotment. In some embodiments, the multiplier is the same for all active network entities. For example, the host system may perform an iterative process to determine the multiplier, and then apply the determined multiplier to the stake value of each active network entity. In some embodiments, steps 406 and 408 may be combined. For example, the host system may determine matching, and network entities that are determined to have a zero, or undefined estimated allotment, may be excluded from the event. In some embodiments, network entities excluded from the event are refunded their stake value, or other deposit (e.g., only active network entities are subject to lose their stake value).

Step 410 includes the host system determining whether an outcome is ready, available, or otherwise known. In some embodiments, step 410 may include receiving outcome data from a network entity (e.g., network entity 120 of FIG. 1). In some embodiments, step 410 may include a host system (e.g., implemented by network entity 110 of FIG. 1) determining the outcome data. The time scale for step 410 may be any suitable time scale, ranging from almost instantaneous (e.g., the outcome is already known but is just then disclosed), to long times (e.g., a week, a month, or a year). In some embodiments, the time scale is estimated, specified, or otherwise indicated when the event is defined (e.g., at step 402).

Step 412 includes the host system determining a settlement, based on the outcome, among the network entities. In some embodiments, after the outcome is available (e.g., when the outcome is an external result), the content data of the active network entities is evaluated against the outcome to determine the settlement. Each actual allotment of the settlement is based not only on the stake value and multiplier, but also on the success of the content data. For example, if a particular active network entity's content data is not successful, their actual allotment may be zero and their stake value is lost to them. In a further example, if a particular network entity's content data is successful, their actual allotment may be equal to their stake value multiplied by the multiplier (e.g., and their deposited stake value may be returned but need not be). In some embodiments, step 412 includes the host system determining actual allotments as well as any difference between the sum of actual allotments and the pool (e.g., when the allotments do not add up to the pool). In some such embodiments, the host system may allocate the difference to one or more successful active network entities, one or more unsuccessful active network entities, another pool associated with another event, any other suitable allocation, or any combination thereof.

Step 414 includes the host system distributing allotments to network entities entitled to an allotment, based on the settlement of step 412. When the actual allotment for each active network entity is determined, a corresponding number of value tokens are caused to be transferred to a beneficiary account associated with each active network entity. In some embodiments, the host system generates a command (e.g., in the form of a smart contract) to allot the actual allotment to the active network entity. For example, in some embodiments, the host system generates a smart contract that includes commands to immutably record the value token transfer in a block of a blockchain, distributed across one or more networks.

In some embodiments, a network entity may submit a stake value, a certainty value, and content data as part of a submission. Accordingly, in some such embodiments, the host system may receive the stake value, the certainty value, and the content data at the same time, and before determining which bids are valid or invalid (e.g., active or excluded). In some embodiments, a network entity may submit a stake value, a certainty value, or both, first without accompanying content data. Then subsequently, the host system may receive content data from the network entity. For example, while the stake value, certainty value, or both may be used by the host system to determine the active network entities and the excluded network entities, as well as the estimated allotments, the content data may be used to determine the actual allotment. Accordingly, in the context of FIG. 4, the content data may be received at any time during staking process 401, or during step 412 when the settlement is determined. To illustrate, the host system may first determine estimated allotments based on received stake values and certainty values, and then receive the corresponding content data subsequently to determine the actual allotments when the outcome is available.

FIG. 5 shows a flowchart of illustrative process 500 for managing an event contingent on an outcome, in accordance with some embodiments of the present disclosure. The illustrative steps of process 500 may be performed by a host system implemented on computing equipment (e.g., as shown in and described in the context of FIG. 1).

Step 502 includes defining an event having a pool. The event is contingent on an outcome. In some embodiments, for example, step 502 is implemented using computing equipment coupled to a network (e.g., network entity 110 of FIG. 1). Defining an event may include, for example, a host system specifying what type of outcome(s) are possible, the expected latency for the outcome (e.g., outcome available next week, available in a year, or unknown), which network entities (e.g., participants) are eligible, what event data is required (e.g., minimum stake, minimum certainty, type of content data), a prize pool, rules and guidelines for the event proceedings, previous results or rankings, any other suitable aspect of an event, or any combination thereof. In some embodiments, step 502 may include a host system communicating, displaying, or otherwise making available to potential network entities, information associated with the event.

Step 504 includes the host system receiving respective event data from each of a plurality of network entities coupled to the network. Event data includes at least a stake value, a certainty value, and content data associated with the outcome. The event data may also include, for example, network entity information (e.g., an identifier, beneficiary account information, a description of the network entity), security information (e.g., an encryption key, password, or other security safeguard), any other suitable data or information, or any combination thereof. In some embodiments, network entities communicate their respective event data to the host system via the network. For example, the host system may have an associated website, to which network entities may submit the event data. In a further example, network entities may transmit the event data to a port at a network address of the host system configured to receive event data. In some embodiments, the host system may provide a predetermined time period for accepting event data. For example, the host system may prescribe a cutoff time, by which all event data that will be considered for the event must be received. In some embodiments, the host system may require all of a pre-determined number of event data submissions to be received before closing the submission process. For example, the host system may receive and accept the first N submissions of event data from network entities, wherein N is a suitable integer. In some embodiments, a network entity may submit a stake value, a certainty value, and content data as part of a single submission. Accordingly, in some such embodiments, the host system may receive the stake value, the certainty value, and the content data at the same time, and before determining which bids are valid or invalid (e.g., active or excluded). In some embodiments, a network entity may submit a stake value, a certainty value, or both, first without accompanying content data. Then subsequently, the host system may receive content data from the network entity. For example, while the stake value, certainty value, or both may be used by the host system to determine the active network entities and the excluded network entities, as well as the estimated allotments, the content data may be used to determine the actual allotment. Accordingly, in the context of FIG. 5, the content data may be received at any time up to step 516, when the settlement is determined. To illustrate, the host system may first determine estimated allotments based on received stake values and certainty values, and then receive the corresponding content data subsequently to determine the actual allotments when the outcome is available.

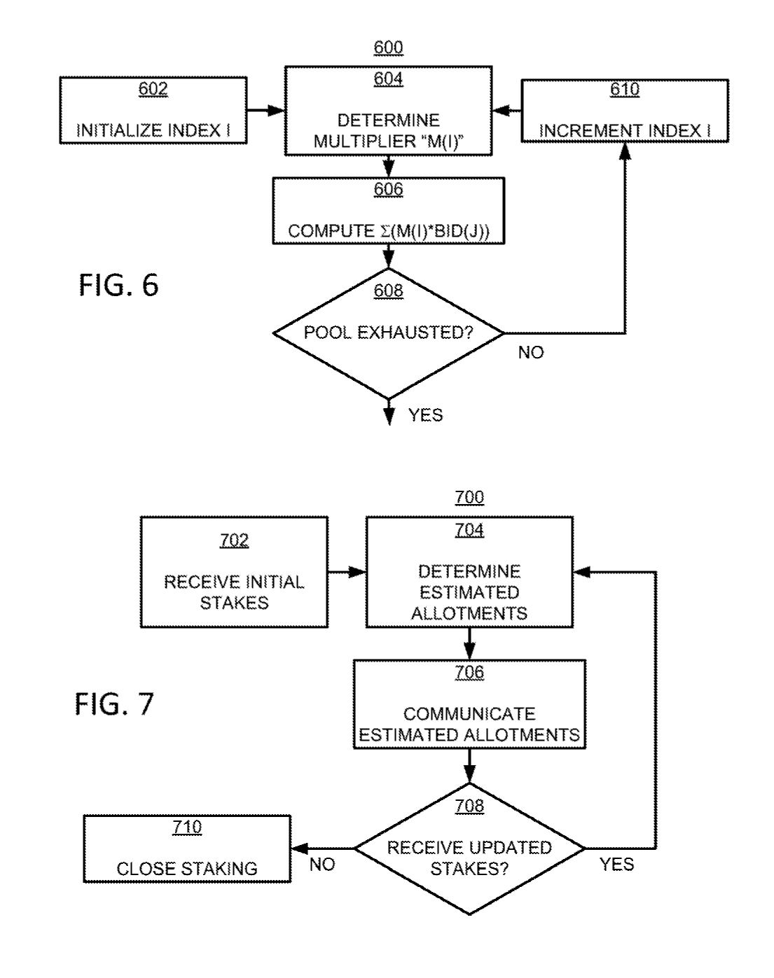

Step 506 includes the host system identifying a subset of network entities to exclude from the event based on at least one of a certainty value and a performance metric. Step 508 includes the host system excluding the subset of network entities from the event, with remaining network entities being active network entities in the event. In some embodiments, step 508 may include the host system notifying or otherwise providing an indication to the excluded network entities that they are excluded. In some embodiments, step 508 may include the host system refunding a submitted stake value (e.g., refunding value tokens submitted as a deposit). For example, the host system may generate and execute a smart contract that includes commands to transfer value tokens to the excluded network entity, in an amount equal to the stake value. The host system may identify network entities to exclude based on certainty value, a performance metric, one or more estimated allotments, or any other criterion or combination thereof. For example, process 600 of FIG. 6 may be used to determine estimated allotments, and which network entities to exclude (e.g., by limiting the index). A performance metric may include a historical performance metric (e.g., based on previous events), a live performance metric (e.g., based on the current event), or a combination thereof (e.g., based on both historical events and the current event). For example, a performance metric may include a subjective opinion received from one or more references (e.g., based on how elegant a solution, model, or answer is deemed), an originality metric (e.g., based on whether content data correlates to other content data), a consistency metric, a concordance metric (e.g., based on how close the content data agrees with an outcome), an accuracy, a precision, an average precision, an F1 score, a logloss value, an area-under-a-curve (AUC), a recall value, mutual information, adjusted mutual information, normalized mutual information, a Rand index, an adjusted Rand index, a completeness, a Fowlkes-Mallows index, a homogeneity value, a V-measure, explained variance, mean absolute error, mean squared error, mean squared log error, median absolute error, root mean square error, an R-squared value, any other suitable metric indicative of performance in one or more events, or any combination thereof.

Step 510 includes the host system computing a respective estimated allotment for each active network entity based on the pool, a respective stake value, and a respective certainty value. For example, the host system may perform process 600 of FIG. 6, or any of the disclosed techniques, to determine estimated allotments. The host system may determine estimated allotments to determine the group of active network entities, the group of excluded network entities, or both.

Step 512 includes the host system communicating the respective estimated allotment over the network to each of the active network entities. For example, the host system may communication the estimated allotments to allow re-bidding or updating of stakes by the network entities. In some embodiments, step 512 may include publishing (e.g., to a webpage), or otherwise making publicly available the estimated allotments.

Step 514 includes the host system determining outcome data corresponding to the outcome. In some embodiments, for example, the host system receives outcome data, against which the content data may be compared. In some embodiments, a judgment-based outcome is included, and the host system may receive the judgment (e.g., succeed/fail, or a non-binary scoring). In some embodiments, a criterion-based outcome is included, and the host system may evaluate the content data in the context of the criterion. In some embodiments, a comparison-based outcome is included, and the host system may compare the content data to one another and score (e.g., rank and sort) or otherwise evaluate (e.g., pass/fail) the content data among one another.

Step 516 includes the host system computing an actual allotment to each respective active network entity based on the pool, the respective stake value, respective content data, at least one multiplier, and the outcome data. In some embodiments, the host system performs step 516 in response to receiving the outcome data. The sum of the actual allotments is referred to as the settlement. An actual allotment is based on the stake value, the multiplier, and the success of the content data. For example, if a particular active network entity's content data is not successful, their actual allotment may be zero and their stake value is lost to them. In a further example, if a particular network entity's content data is successful, their actual allotment may be equal to their stake value multiplied by the multiplier (e.g., and their deposited stake value may be returned but need not be). In some embodiments, step 412 includes the host system determining actual allotments as well as any difference between the sum of actual allotments and the pool (e.g., when the allotments do not add up to the pool). In some such embodiments, the host system may allocate the difference to one or more successful active network entities, one or more unsuccessful active network entities, another pool associated with another event, any other suitable allocation, or any combination thereof.

Step 518 includes the host system generating results data based on the outcome data. For example, the host system may generate results similar to results 316 of FIG. 3. Step 520 includes communicating the results data over the network to be displayed. For example, the results may be communicated over the network to the network entities to be displayed by display devices (e.g., a monitor or other display screen) included in computing equipment associated with each network entity.

Step 522 includes the host system generating a command to allot the actual allotment to each respective active network entity entitled to allotment by causing a respective beneficiary account associated with the active network entities entitled to allotment to receive the respective actual allotment. In some embodiments, the host system generates a command (e.g., in the form of a smart contract) to allot the actual allotment to the active network entity. For example, in some embodiments, the host system generates a smart contract that includes commands to immutably record the value token transfer in a block of a blockchain, distributed across one or more networks.

FIG. 6 shows a flowchart of illustrative process 600 for determining estimated allotments for an event, in accordance with some embodiments of the present disclosure. A host system may perform the illustrative steps of process 600 iteratively to determine estimated allotments. Process 600 is an example of matching and may be performed on, for example, a sorted list of event data. For example, process 600 may be performed by the host system to determine the cutoff or threshold between active network entities and excluded network entities.

Step 602 includes the host system initializing index I. In some embodiments, the host system initializes process 600 by setting index value I to “1” as the first index. The initialized index may be, but need not be, one, and may be any suitable index (e.g., numerical, alphanumerical, or otherwise) that may be incremented.

Step 604 includes the host system determining a multiplier associated with index I. In some embodiments, the sorted event data associated with the index is considered, and the multiplier is determined based on the corresponding certainty value, or certainty metric derived thereof. For example, if the index is “3” then the third set of event data is considered, and the host system determines the multiplier as the inverse certainty value of the third event data.

Step 606 includes the host system computing a sum of estimated allotments, based on the multiplier. In some embodiments, the sum is performed for event data 1 to I. Each term (e.g., each summand) of the summed sequence is equal to the corresponding stake value multiplied by the multiplier determined at step 604. For example, if the index is “7” then the sum includes seven terms and is equal to the sum of the first seven stake values (e.g., of the sorted event data) multiplied by the multiplier.

Step 608 includes the host system comparing the sum of step 606 to a pool associated with the event to determine if the pool is exhausted. The sum of the estimated allotments of step 606 represents the maximum in estimated prizes to be distributed. In some embodiments, if the sum is less than the pool, then the host system proceeds to step 610 to increment the index and expand the group of active network entities by one. If the sum is equal to the pool, greater than the pool, or within a threshold of the pool, the host system may exit process 600, with the current index being equal to the number of active network entities. For example, if the index “I” is equal to “10” and the pool is determined to the exhausted at step 608, then the number of active network entities is ten. In some embodiments, the pool is not considered exhausted until the sum is greater than the pool by a threshold. In some embodiments, the host system may determine the index at which the pool is exhausted, and then proceed to step 610 for one final iteration to increment the multiplier by one index. This may lead to a sum of estimated allotments greater than the pool. For example, this circumstance may be desired if it is expected/likely that some active network entities will be unsuccessful, and it is unlikely that the actual allotments will be greater than the pool. The host system may apply a statistical computation to determine an expected payout based on historical data from previous events, and accordingly allow the sum of estimated allotments to be greater than the pool.

Step 610 includes the host system incrementing index I, if it is determined at step 608 that the pool is not anticipated to be exhausted. In some embodiments, the host system updates or otherwise replaces the current index with an index equal to the current index plus one. In some embodiments, step 610 includes the host system incrementing the index by more than one to skip over event data that is not valid. Accordingly, step 610 may include evaluating the network entity associated with the potential new index and determining that the network entity will be excluded.

FIG. 7 shows a flowchart of illustrative process 700 for managing stakes, in accordance with some embodiments of the present disclosure. A host system may perform the illustrative steps of process 700 iteratively to determine the submitted stakes used for the event. Process 700 is an example of staking and re-staking and may provide for some further competition among network entities. For example, process 700 may be performed by the host system to determine the event data that will be used in determining a settlement when the outcome is available.

Step 702 includes the host system receiving initial event data from a plurality of network entities. Each event data may include, for example, a stake value, a certainty value, content data, network entity information (e.g., an identifier, beneficiary account information, a description of the network entity), security information (e.g., an encryption key, password, or other security safeguard), any other suitable data or information, or any combination thereof. In some embodiments, network entities communicate their respective event data to the host system via the network. For example, the host system may have an associated website, to which network entities may submit the event data. Step 702 may be similar to step 404 of FIG. 4 or step 504 of FIG. 5, for example.

Step 704 includes the host system determining estimated allotments for at least some of the network entities. In some embodiments, step 704 includes the host system performing process 600 of FIG. 6.

Step 706 includes the host system communicating estimated allotments to at least some of the network entities. In some embodiments, step 706 includes the host system transmitting each estimated allotment to the respective network entity (e.g., and optionally to no other network entity). In some embodiments, step 706 includes the host system transmitting each estimated allotment to all of the network entities (e.g., and optionally without an identifier as to which estimated allotment corresponds to which network entity). In some embodiments, step 706 includes the host system publishing or otherwise making available for display the estimated allotments to any or all network entities.

Step 708 includes the host system determining whether updated event data have been received. In response to step 706, network entities may desire to update their event data to improve their chance of winning, improve their expected payout, move into the group of active network entities, move out of the excluded network entities, or otherwise change their presence in the event. Accordingly, network entities may submit updated event data to the host system. The host system may, at step 708, determine whether updated event data has been received. In some embodiments, step 708 may include a time limit, a limit in the number of updates per network entity, a limit in the total number of updates for all network entities, or a combination thereof.

Step 710 includes the host system closing the staking process after any updated stakes have been received. In some embodiments, the host system does not accept updates in event data after closing staking. For example, the host system may determine settlements based on the updated event data.

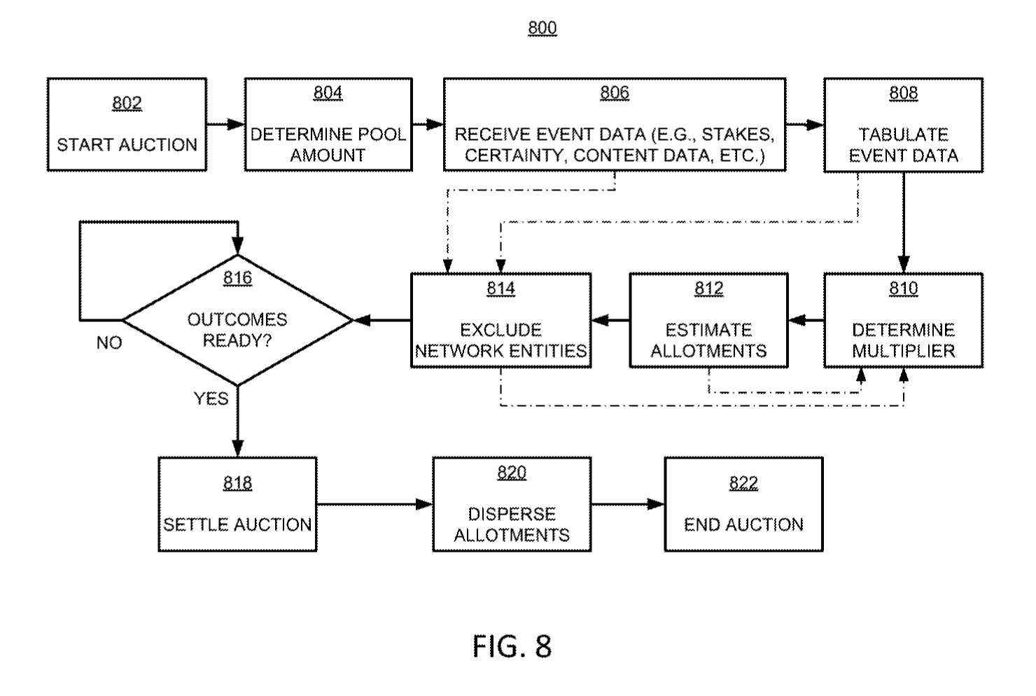

FIG. 8 shows a flowchart of illustrative process 800 for implementing an auction event, in accordance with some embodiments of the present disclosure.

Step 802 includes the host system starting the auction, which is contingent on an outcome. In some embodiments, for example, step 802 is implemented using computing equipment coupled to a network (e.g., network entity 110 of FIG. 1). Defining an event may include, for example, specifying what type of outcome(s) are possible, the expected latency for the outcome (e.g., outcome available next week, available in a year, or unknown), which network entities (e.g., participants) are eligible, what event data is required (e.g., minimum stake, minimum certainty, type of content data), a prize pool, rules and guidelines for the event proceedings, previous results or rankings, any other suitable aspect of an event, or any combination thereof. In some embodiments, step 802 may include a host system communicating, displaying, or otherwise making available to potential network entities, information associated with the auction.

Step 804 includes the host system determining a pool amount associated with the auction. In some embodiments, the pool amount may be pre-determined (e.g., the host system always determines the same pool). In some embodiments, the pool amount may depend on the event and outcome. The pool amount may include any suitable unit such as, for example, a currency, a cryptocurrency, a token, a real asset, a digital asset, a resource (e.g., access to computing resources), any other valuable, or any combination thereof. In some embodiments, the pool may include a unit different from the stake value. For example, the pool may be defined in value tokens of type A, network entities may stake value tokens of type B, and the settlement is to be provided in value tokens of type B (e.g., having an exchange rate with type A).

Step 806 includes the host system receiving event data including stakes, certainty values, and content data. The event data includes at least a stake value, a certainty value, and content data. In some embodiments, network entities communicate their respective event data to the host system via the network. For example, the host system may have an associated website, to which network entities may submit the event data. In a further example, network entities may transmit the event data to a port at a network address of the host system configured to receive event data. In some embodiments, the host system may limit the time period for, and number of, submissions. In some embodiments, step 806 may be rearranged, split, or otherwise modified, in accordance with the present disclosure. For example, in some embodiments, a network entity may submit a stake value, certainty value, or both, prior to step 808, and then subsequently submit contents at a later time (e.g., at step 814 or 818) to determine an actual allotment. The content data need not be required until the actual allotment is determined, and accordingly may be received by the host system at any suitable time up to determination of the actual allotment. In an illustrative example, the host system may define a first time period for submitting a stake value and a certainty value, and a second time period for submitting content data. The first and second time periods may, but need not, overlap.

Step 808 includes the host system tabulating the event data received at step 806. In some embodiments, the host system sorts the event data. For example, the host system may sort the event data by certainty value. In some embodiments, the host system need not sort the event data, and may use searching or other techniques to perform subsequent steps of process 800. In some embodiments, the host system may store the event data in a data structure configured to allow searching, sorting, recalling, updating, flagging, any other suitable operations, or any combination thereof. In some embodiments, the event data need not be tabulated or stored in a data structure by the host system. For example, the host system may cause the event data to be stored and may access the stored event data as needed without first tabulating or structuring the event data.

In some embodiments, steps 810, 812, and 814 may be combined, rearranged, or otherwise modified in accordance with the present disclosure. For example, the host system may determine matching and network entities to be excluded from the event concurrently.

Step 810 includes the host system determining one or more multiplier values associated with at least some of the network entities. In some embodiments, the host system determines a multiplier for each network entity, for multiplying the corresponding stake value to determine an estimated allotment (e.g., at step 812). In some embodiments, the multiplier is the same for all active network entities. For example, the host system may perform an iterative process to determine the multiplier, and then apply the determined multiplier to the stake value of each active network entity.

Step 812 includes the host system estimating allotments for at least some of the network entities. For example, step 812 may include any of the illustrative processes of step 408 of FIG. 4, step 510 of FIG. 5, process 600 of FIG. 6, and step 704 of FIG. 7.

Step 814 includes the host system excluding at least some of the network entities. In some embodiments, network entities excluded from the event are refunded their stake value, or other deposit (e.g., only active network entities are subject to losing their stake value). For example, step 814 may include any of the illustrative processes of staking process 401 of FIG. 4, and step 508 of FIG. 5.

Step 816 includes determining whether outcome data is available. For example, step 816 may include any of the illustrative processes of step 410 of FIG. 4 and step 514 of FIG. 5.

Step 818 includes the host system settling the auction by determining actual allotments to the active network entities. For example, step 814 may include any of the illustrative processes of settlement process 411 of FIG. 4, and step 516 of FIG. 5.

Step 820 includes the host system dispersing the actual allotments to the network entities entitled to allotment. For example, step 820 may include any of the illustrative processes of step 414 of FIG. 4, and step 522 of FIG. 5.

Step 822 includes the host system ending the auction. In some embodiments, step 822 includes the host system publishing, communicating, or otherwise making public the results of the event. The results may include actual allotments, performance metrics, the outcome itself, a leftover pool amount, statistics based on the settlement, any other suitable information, or any combination thereof.

It is contemplated that the steps or descriptions of FIGS. 4-8 may be used with any other embodiment of the present disclosure. In addition, the steps and descriptions described in relation to FIGS. 4-8 may be done in alternative orders or in parallel in accordance with the present disclosure. Any of the steps of FIGS. 4-8 may also be skipped or omitted from a process. Furthermore, it should be noted that the features and limitations described in any embodiments may be applied to any other embodiments herein. For example, flowcharts or examples relating to any embodiment may be combined with any other embodiments in a suitable manner, done in different orders, performed with addition steps, performed with omitted steps, or done in parallel. For example, each of these steps may be performed in any order or in parallel or substantially simultaneously to reduce lag or increase the speed of the system or method. In a further example, any of the steps described herein may be performed fully, partially, piecewise or on any other suitable schedule to any suitable completeness in accordance with the present disclosure. In addition, the systems and methods described herein may be performed in real time. It should also be noted that the systems and/or methods described above may be applied to, or used in accordance with, other systems and/or methods.

The following examples illustrate some aspects of the present disclosure. Accordingly, the following examples are discussed in the context of system 100 of FIG. 1, and the illustrative processes of FIGS. 4-8. As used herein, the term “contingent win” refers to an estimated allotment. As used herein, the term “actual win” refers to an actual allotment. As used herein, the terms “bid” and “bidder” refer to a “stake” and “participant,” respectively. As used herein, the term “single price” refers to a multiplier.

In an illustrative example regarding an event, there is a fixed pool of $1,000 and bidders may bid for that prize (e.g., in full amount or partially). Bidder A has a bid size of $100 and a payout limit of 0.1 (e.g., certainty, or probability). Bidder B has a bid size of $120 and a payout limit of 6× (e.g., payout ratio, multiplier or odds). Accordingly, Bidder A stands to be paid $100×10=$1,000 if a future outcome (which could vary across bidders) also materializes (e.g., Bidder A succeeds). In some embodiments, for example, the $1,000 is the net payout and the bid size of $100 is returned upon Bidder A being successful. Therefore, Bidder A places out $100 and returns $1,100, which includes the bid amount (e.g., the stake). Regarding Bidder B, if they are successfully included in the event and their content data is successful against the future outcome, they would be paid $720 and in addition their bid amount of $120 would also be returned. In some embodiments, the future outcome could be a performance metric for Bidder A to meet a predetermined standard in the context of a certain future event, the outcome of which would be known to the bidders (e.g., revealed) only at a future time after the auction is closed. In some embodiments, if the future outcome standard is not met, the bid amount would be lost and would not be refunded to Bidder A. In some embodiments, if the bidding multiplier (e.g., 1/certainty value) is not aggressive enough, the bid amount would not be included in the event and there would be no risk of loss to the bidder after the event closes (to bidding) and the bid amount would be released without loss (e.g., participant would not lose the stake).

Some embodiments of the present disclosure include the following aspects. A single market clearing price, or auction settlement price, is used to encourage bidders to bid higher (e.g., a Dutch auction being a reference). Bidders, if not protected by single auction price, may fear the winner's curse (e.g., being too confident) and accordingly remain conservative in bidding. In some such circumstances, the event may become less competitive (e.g., which is typically not desired). During the bidding process (e.g., the key price discovery process), a single market clearing price would provide an unambiguous signal to network entities (e.g., bids below auction price would definitely not be qualified for the auction), thus potentially guiding network entities that can afford to submit higher stakes. The single price may be determined and published before the future outcome (e.g., applicable to each network entity individually) is determined, such that those stakes that are not qualified or are excluded (e.g., because of a low bid price) would be set free and their deposited amount (e.g., their stake) would be immediately released. This may be especially important for auction results based on a future outcome having a long wait time (e.g., four weeks or more). This may also be important for the existence of multiple concurrent or overlapping events, which brings high implied penalty in case of lock-up (e.g., having opportunity cost, and high cost of capital) to participants if their stakes could not be freed up to participate into other events. For example, if a future outcome takes four weeks to realize but three days later there would be another, separate event that as usual would require a bid amount deposit, the participant would benefit from being excluded. In some circumstances, the excluding of network entities could also generate investment opportunities (e.g., interest income, liquidity benefit, or the bid amount being in a currency of volatile value). In some embodiments, instead of a market clearing quantity (e.g., payout one by one in order to consume the entire pool), the market clearing quality (e.g., bid price) would in many cases result in some of the pool left over (the sum of the actual allotments is less than the pool). For example, winners may be rewarded based on one or more factors other than bid price, because all included bidders might not meet the future outcome requirement (e.g., some are unsuccessful). In some circumstances, even if all the qualified bids could meet the requirement of the conditional future outcome and the pool is exactly exhausted, the auction organizer may set rules to give partial allotments to qualified bids of lower performance (e.g., in conditional future outcome and/or other factors) in order to free pool money to reward those with higher performance. In some circumstances, even if there are bidders that fail the future outcome, the host system may still give partial fills to qualified bids of successful future outcome but of lower performance in order to free even more pool money to reward qualified higher performers.

A host system may define an event without a single price that intends to exhaust the pool (e.g., $3,000 in this case). Estimated allotments would be filled from Nos. 1-8, sorted by the multiplier (e.g., certainty), with No. 8 getting a partial fill (e.g., less than the bid size multiplied by the multiplier, as shown in Table 6.

TABLE 6
Event having 10 participants without a single price.

| | | Multiplier | | Cumulative Contingent |
|---|---|---|---|---|
| No. | Bid size | (1/Certainty) | Contingent Win | Win |
| 1 | 100 | 1.7 | 170 | 170 |
| 2 | 200 | 1.8 | 360 | 530 |
| 3 | 100 | 2.05 | 205 | 735 |
| 4 | 270 | 2.2 | 594 | 1,329 |
| 5 | 80 | 2.3 | 184 | 1,513 |
| 6 | 340 | 2.7 | 918 | 2,431 |
| 7 | 50 | 3.1 | 155 | 2,586 |
| 8 | 500 | 3.9 | 1,950 | 4,536 |
| 9 | 100 | 4.1 | 410 | 4,946 |
| 10 | 200 | 4.3 | 860 | 5,806 |

TABLE 7
Event having 10 participants without a single price,
with an available outcome.

| | Bid | Multiplier | | Future | Actual | Cumulative Actual |
|---|---|---|---|---|---|---|
| No. | size | (1/Certainty) | Contingent Win | Outcome | Win | Win |
| 1 | 100 | 1.7 | 170 | 1 | 170 | 170 |
| 2 | 200 | 1.8 | 360 | 0 | 0 | 170 |
| 3 | 100 | 2.05 | 205 | 1 | 205 | 375 |
| 4 | 270 | 2.2 | 594 | 0 | 0 | 375 |
| 5 | 80 | 2.3 | 184 | 1 | 184 | 559 |
| 6 | 340 | 2.7 | 918 | 0 | 0 | 559 |
| 7 | 50 | 3.1 | 155 | 1 | 155 | 714 |
| 8 | 500 | 3.9 | 1,950 | 1 | 1,950 | 2,664 |
| 9 | 100 | 4.1 | 410 | 1 | 410 | 3,074 |
| 10 | 200 | 4.3 | 860 | 1 | 860 | 3,934 |

Table 7 shows information about the event of Table 6, with the outcome available. Referencing Table 7, if a future outcome requirement cannot be fulfilled by Nos. 1-8, No. 9 may be partially filled. The column “Future Outcome” of Table 7 indicates success or failure with a “0” or “1” value. The technique of Table 7 may be applied to prediction competitions that are highly skill-based (e.g. based on quantitative analysis capability). As the participants having successful content data of Table 7 are considered in ascending order, a spread in capabilities between the most and least confident winners (e.g., the lowest and highest multiplier) typically gets wider. For example, No. 1 is more confident and possibly more capable (e.g., especially if the competition is highly skill-based) and may not appreciate a multiplier of 1.7× while No. 9 achieves a higher multiplier of 4.1×. Further, in some circumstances, the lower (e.g., in terms of certainty) the bidder (e.g., No. 9) is, the less confident and usually technically less capable.

In some embodiments, the host system uses a same auction price for all potential winning participants to determine an estimated allotment before the future outcome is determined. As shown illustratively by process 600 of FIG. 6, for example, the host system may iterate by counting down from No. 1 with all included participant(s) using the same highest multiplier of the included participants of that iteration (i.e., lowest confidence among them) until the pool of $3,000 is exhausted. To illustrate (e.g., referencing participants shown in Table 8), the first iteration includes No. 1 only, with a settlement of $100×1.7=$170, which is less than the pool of $3,000. The second iteration includes Nos. 1 and 2, with a total bid size $100+200=$300, and when applying the highest multiplier for the two included bidders, which is 1.8×, the settlement of $300×1.8=$540 is still less than the pool of $3,000. The third iteration includes Nos. 1-3, with a total bid size of $400 and a highest multiplier of 2.05, which results in a settlement of $400×2.05=$1,080, which is still less than the pool of $3,000. Continuing, the host system iterates until No. 6 (e.g., and in some embodiments, No. 7, as shown in Table 9). Referencing Table 8, the host system by using a multiplier of 2.7× would not be able to meet the bid limit (e.g., equal to the total bid size×the single multiplier) of No. 7 (e.g., having a multiplier of 3.1).

TABLE 8
Event having 10 participants with a single price,
and estimated allotments.

| | Bid | Multiplier | Single | Contingent | Cumulative |
|---|---|---|---|---|---|
| No. | size | (1/Certainty) | Multiplier | Win | Contingent Win |
| 1 | 100 | 1.7 | 2.7 | 270 | 270 |
| 2 | 200 | 1.8 | 2.7 | 540 | 810 |
| 3 | 100 | 2.05 | 2.7 | 270 | 1,080 |
| 4 | 270 | 2.2 | 2.7 | 729 | 1,809 |
| 5 | 80 | 2.3 | 2.7 | 216 | 2,025 |
| 6 | 340 | 2.7 | 2.7 | 918 | 2,943 |
| 7 | 50 | 3.1 | 2.7 | 135 | 3,078 |
| 8 | 500 | 3.9 | 2.7 | 1,350 | 4,428 |
| 9 | 100 | 4.1 | 2.7 | 270 | 4,698 |
| 10 | 200 | 4.3 | 2.7 | 540 | 5,238 |

In some embodiments, a multiplier of 2.7× (e.g., associated with No. 6) is the settlement multiplier and the unallotted pool amount of $3,000-$2,943=$57 may be used for extra allotments to participants with strong performance in other parameters or multi-factors (e.g., such as strong performance on future outcome). In some embodiments, the host system may use the next bidding multiplier of 3.1 (e.g., associated with No. 7), as shown in Table 9. As shown in Table 9, the pool amount of $3,000 matches only up to No. 6, though No. 7 is now also determined to be qualified (e.g., included). In some embodiments, No. 7 may be filled with zero (e.g., have an estimated allotment of zero). In some embodiments, Nos. 6 and 7 may be filled partially (e.g., as shown in Table 9, the pool is exhausted by the estimated allotments with a partial fill of No. 6). In some embodiments, the host system does not release (e.g., refund) the stake of No. 7 after bidding closes and maintains the stake until the future outcome is determined. For example, because the multiplier is qualified, and some bidders likely will not be able to fulfil the future outcome (e.g., be successful), some unallotted pool money may be available for distribution to No. 7. For example, even after No. 6 is completely filled, if the remaining unallotted pool is large enough, then at least a partial allotment may be made to No. 7.

Once the host system determines the single auction price (e.g. multiplier of 3.1× for Table 9), the host system may wait for the future outcome to be determined (e.g., receive outcome data). In some embodiments, No. 8 to 10, and beyond, are considered not included in the event and their bid amount would be released, if applicable. Table 10 shows results for the event of Table 9, based on the single multiplier of 3.1×, after the outcome is known and the actual allotments up to No. 7 are filled. However, only $1,023 of the pool of

TABLE 9
Event having 10 participants with a single price,
and estimated allotments.

| | | Multiplier | Single | Contingent | Cumulative |
|---|---|---|---|---|---|
| No. | Bid | (1/Certainty) | Multiplier | Win | Contingent Win |
| 1 | 100 | 1.7 | 3.1 | 310 | 310 |
| 2 | 200 | 1.8 | 3.1 | 620 | 930 |
| 3 | 100 | 2.05 | 3.1 | 310 | 1,240 |
| 4 | 270 | 2.2 | 3.1 | 837 | 2,077 |
| 5 | 80 | 2.3 | 3.1 | 248 | 2,325 |
| 6 | 340 | 2.7 | 3.1 | 1,054 | 3,379 |
| 7 | 50 | 3.1 | 3.1 | 155 | 3,534 |
| 8 | 500 | 3.9 | 3.1 | 1,550 | 5,084 |
| 9 | 100 | 4.1 | 3.1 | 310 | 5,394 |
| 10 | 200 | 4.3 | 3.1 | 620 | 6,014 |

$3,000 is exhausted through No. 7. For No. 8 and below, the multiplier of 3.1× does not meet their bid price of 3.9× or higher. In some embodiments, the unallotted pool after No. 7 may be used for another pool associated with another event. In some embodiments, the unallotted pool after No. 7 may be allocated within the same event to further reward participants achieving relatively better performance (e.g. if the future outcomes are not binary 0 or 1). For example, for multi-factor consideration, the unallotted pool may be allocated to better performers based on one or more factors. In some embodiments, more of the unallotted pool may be allotted to participants having lower certainty, as they have taken a bigger risk to win the bid (e.g., see Table 10).

Referencing Table 10, in some embodiments, the host system may continue iteration further to allot the unallotted pool, updating the single multiplier until the pool of $3,000 is exhausted. For example, referencing Table 10 with the future outcome(s) known, only $1,023 of the pool is exhausted. To reach $3,000, the host system may extend matching to No. 8. For example, the host system may prefer to have a single multiplier to all winning bidders. No. 1, 3, 5, and 7 with success outcome “1,” as shown in Table 10, have a total bid size (e.g., sum of stakes) of $330. The host system may apply the multiplier based on the next successful bidder (i.e., 3.9× associated with No. 8). The total allotments for Nos. 1, 3, 5 and 7) with a multiplier of 3.9 is now 3.9×330=$1,287, with a maximum left over for No. 8 of $3,000-1,287=$1,713. Because the stake of No. 8 is $500, the estimated allotment of $500×3.9=$1,950 more than exhausts the remaining $1,713. Accordingly, in this example, the settlement multiplier may be 3.9×.

TABLE 10
Event having 10 participants with a single price,
and an available outcome.

| | Bid | | Realized | Contingent | Future | Actual | Cumulative |
|---|---|---|---|---|---|---|---|
| No. | size | Initial Multiplier | Multiplier | Win | Outcome | Win | Actual Win |
| 1 | 100 | 1.7 | 3.1 | 310 | 1 | 310 | 310 |
| 2 | 200 | 1.8 | 3.1 | 620 | 0 | 0 | 310 |
| 3 | 100 | 2.05 | 3.1 | 310 | 1 | 310 | 620 |
| 4 | 270 | 2.2 | 3.1 | 837 | 0 | 0 | 620 |
| 5 | 80 | 2.3 | 3.1 | 248 | 1 | 248 | 868 |
| 6 | 340 | 2.7 | 3.1 | 1,054 | 0 | 0 | 868 |
| 7 | 50 | 3.1 | 3.1 | 155 | 1 | 155 | 1,023 |
| 8 | 500 | 3.9 | N/A | 1,950 | 1 | 1,950 | 2,973 |
| 9 | 100 | 4.1 | N/A | 410 | 1 | 410 | 3,383 |
| 10 | 200 | 4.3 | N/A | 860 | 1 | 860 | 4,243 |

In some embodiments, the bid amount would be filled with the most aggressive multiplier first (e.g., least required payout ratio for the unallotted pool). For example, No. 8 may be partially filled with $1713 (e.g., only about 88% of $1950), which corresponds to a qualified stake of $1713/3.9=$439.23 while Nos. 1, 3, 5 and 7 would be completely filled (e.g., the actual allotment is based on the entire stake and the multiplier). In some circumstances, Example 4 may be similar to Example 3, except that all of the bid amounts (e.g., stakes), if required, are locked in by the host system until the future outcomes are realized. The estimated single price described in Example 3 would, in the context of Example 4, be the indicative minimum multiplier or payout ratio. For example, if all of the bidders Nos. 1-7 were to have their outcomes statuses as success (“1”), the minimum multiplier (i.e., 1.7) might become the multiplier for determining the settlement. In some embodiments, unlike Example 3, any and all participants may be qualified (e.g., included) for the event and wait until the outcome column is released (e.g., their stakes are locked in). In some such embodiments, one advantage may be that bidders knowing the minimum multiplier for the event settlement. In some such embodiments, another advantage may be that bidders are informed of some indicative ranges of higher multipliers above the minimum multiplier during the event, which may encourage bidding. In some such embodiments, another advantage may be that the host system may deliver a higher single multiplier (e.g., payout ratio) than Example 3 because only successful outcome “1” would stay to exhaust the pool while maintaining all the benefits of a single settlement multiplier for everyone. For example, this may encourage a sense of fairness, which may encourage bidders to submit a lower multiplier.

In some embodiments, a pool amount need not be fixed, and may vary. For example, in some embodiments, participants with outcome result “0” lose their bid amount. In some embodiments, the lost bid amounts (e.g., which may be destroyed and/or gained by the host system) may be used to match bids of otherwise partial fills. In some embodiments, the lost stakes may be used, fully or partially, for another pool. In some embodiments, the settlement price of Table 10, subsidized by the unsuccessful bidders' lost amount, could be improved in favor of the successful bidders. The bidders' lost stakes, if assigned to increase the pool size in the context of Example 4, may potentially result in a larger multiplier to the bidders as the pool amount becomes bigger and iteration may therefore go down further to bids of lower certainty.

In some embodiments, the present disclosure may be applied to a cross-token event system. For example, bids may be in the form of cryptocurrencies, virtual assets (e.g., value tokens), or both. The host system may be configured to accept different types of tokens or cryptocurrencies for bidding. For example, a type A token is in use and undergoes a regular auction to have a recent price of type A to type B. Further, before the event opens for bidding, a reference date corresponding to a reference exchange rate (e.g. A/B, or B/C) is fixed. To illustrate, participants may submit a stake from a selected list of value tokens. Exchange rates for the various value tokens may be referenced, floating on regular intervals, fixed at auction close, or otherwise determined. A value token of type C, translated into an equivalent amount of a type A value token, may be submitted as a stake similar to if it were a type A value token. In some embodiments, participants may compete in an event using different value tokens. For example, during staking, a participant need not convert among value tokens. For example, participant A may be included in the event and may succeed. Participant A's type C value token may then be returned, and they may receive their actual allotment in type A value tokens. In a further example, if participant A does not succeed, they may surrender their type C value tokens. In some embodiments, the type C value token would be auctioned to other participants that staked type A value tokens. In some embodiments, the surrendered type C value token may be sold through one or more exchanges into type B value tokens, and the type B value tokens are auctioned to type A value token users as the prize. In some embodiments, having a floating pool amount, any lost type C value tokens may be converted into the pool's denomination and the pool size may be increased for distributing to winning bidders.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims.

1. A computer network-based method, comprising:
defining, by computing equipment coupled to a network, an event comprising at least one pool, wherein the event is contingent on at least one outcome;
receiving, at the computing equipment, respective event data from each of a plurality of network entities coupled to the network, wherein each of the respective event data comprises a stake value, a certainty value, and content data associated with the at least one outcome;
identifying, by the computing equipment, a subset of network entities to exclude from the event based on at least one of a certainty value and a performance metric;
excluding the subset of network entities from the event, with remaining network entities being active network entities in the event;
computing, by the computing equipment, a respective estimated allotment for each active network entity based on the at least one pool, a respective stake value, and a respective certainty value;
communicating, over the network using the computing equipment, to each of the active network entities the respective estimated allotment;
determining, by the computing equipment, outcome data corresponding to the at least one outcome;
in response to receiving the outcome data, computing an actual allotment to each respective active network entity based on the at least one pool, the respective stake value, respective content data, at least one multiplier, and the outcome data;
generating, using the computing equipment, results data based on the outcome data;
communicating over the network, using the computing equipment, the results data to be displayed; and
generating a command, using the computing equipment, to allot the actual allotment to each respective active network entity entitled to allotment by causing a respective beneficiary account associated with the active network entities entitled to allotment to receive the respective actual allotment.

2. The method of claim 1, wherein the performance metric comprises at least one of a historical performance metric and a live performance metric.

3. (canceled)

4. The method of claim 1, wherein causing the respective beneficiary account associated with the active network entities entitled to allotment to receive the respective actual allotment comprises updating a database stored in an immutable distributed network.

5. The method of claim 1, wherein identifying the subset further comprises:
sorting the data from the plurality of network entities based on certainty values;
determining a threshold value based on the certainty values, the at least one pool, and stake values; and
identifying the subset based on the threshold value.

6. The method of claim 1, wherein the outcome is expected to be available at a future time, and wherein the content data comprises prediction data associated with the at least one outcome.

7. (canceled)

8. (canceled)

9. The method of claim 1, further comprising determining the multiplier based on at least one of the certainty values.

10. (canceled)

11. (canceled)

12. (canceled)

13. (canceled)

14. The method of claim 1, wherein the network comprises a plurality of nodes that form a sub-network on which an immutable database is distributed, and wherein receiving the respective event data comprises updating the immutable database to reflect the respective event data.

15. (canceled)

16. (canceled)

17. (canceled)

18. (canceled)

19. (canceled)

20. (canceled)

21. (canceled)

22. (canceled)

23. (canceled)

24. The method of claim 1, further comprising:
receiving at least one update to event data from a respective active network entity of the active network entities; and
updating the event data based on the update.

25. The method of claim 24, wherein, in response to receiving the at least one update, the method further comprises:
computing, by the computing equipment, an updated respective estimated allotment for each active network entity based on the update; and
communicating, over the network using the computing equipment, to each of the active network entities the respective updated estimated allotment.

26. (canceled)

27. (canceled)

28. (canceled)

29. (canceled)

30. (canceled)

31. (canceled)

32. The method of claim 1, wherein excluding the subset of network entities further comprises generating and communicating an indication of exclusion over the network to at least the subset of network entities.

33. (canceled)

34. (canceled)

35. (canceled)

36. (canceled)

37. (canceled)

38. (canceled)

39. A system comprising:
computing equipment coupled to a network, the computing equipment configured to:
define an event comprising at least one pool, wherein the event is contingent on at least one outcome;
receive respective event data from each of a plurality of network entities coupled to the network, wherein each of the respective event data comprises a stake value, a certainty value, and content data associated with the at least one outcome;
identify a subset of network entities to exclude from the event based on at least one of a certainty value and a performance metric;
exclude the subset of network entities from the event, with remaining network entities being active network entities in the event;
compute a respective estimated allotment for each active network entity based on the at least one pool, a respective stake value, and a respective certainty value;
communicate to each of the active network entities the respective estimated allotment;
determine outcome data corresponding to the at least one outcome;
in response to receiving the outcome data, compute an actual allotment to each respective active network entity based on the at least one pool, the respective stake value, respective content data, at least one multiplier, and the outcome data;
generate results data based on the outcome data;
communicate over the network the results data to be displayed; and
generate a command to allot the actual allotment to each respective active network entity entitled to allotment by causing a respective beneficiary account associated with the active network entities entitled to allotment to receive the respective actual allotment.

40. The system of claim 39, wherein the performance metric comprises at least one of a historical performance metric and a live performance metric.

41. (canceled)

42. The system of claim 39, wherein the computing equipment is further configured to cause the respective beneficiary account associated with the active network entities entitled to allotment to receive the respective actual allotment by updating a database stored in an immutable distributed network.

43. The system of claim 39, wherein the computing equipment is further configured to identify the subset by:
sorting the data from the plurality of network entities based on certainty values;
determining a threshold value based on the certainty values, the at least one pool, and stake values; and
identifying the subset based on the threshold value.

44. The system of claim 39, wherein the outcome is expected to be available at a future time, and wherein the content data comprises prediction data associated with the at least one outcome.

45. (canceled)

46. (canceled)

47. The system of claim 39, wherein the computing equipment is further configured to determine the multiplier based on at least one of the certainty values.

48. (canceled)

49. (canceled)

50. (canceled)

51. (canceled)

52. The system of claim 39, wherein the network comprises a plurality of nodes that form a sub-network on which an immutable database is distributed, and wherein the computing equipment is further configured to update the immutable database to reflect the respective event data.

53. (canceled)

54. (canceled)

55. (canceled)

56. (canceled)

57. (canceled)

58. (canceled)

59. (canceled)

60. (canceled)

61. (canceled)

62. The system of claim 39, wherein the computing equipment is further configured to:
receive at least one update to event data from a respective active network entity of the active network entities; and
update the event data based on the update.

63. The system of claim 62, wherein in response to receiving the at least one update, the computing equipment is further configured to:
compute an updated respective estimated allotment for each active network entity based on the update; and
communicate, over the network, to each of the active network entities the respective updated estimated allotment.

64. (canceled)

65. (canceled)

66. (canceled)

67. (canceled)

68. (canceled)

69. (canceled)

70. The system of claim 39, wherein the computing equipment is further configured to generate and communicate an indication of exclusion over the network to at least the subset of network entities.

71. (canceled)

72. (canceled)

73. (canceled)

74. (canceled)

75. (canceled)

76. (canceled)

77. A non-transient computer readable medium comprising non-transitory computer readable instructions, the non-transitory computer readable instructions comprising:
an instruction for defining, by computing equipment coupled to a network, an event comprising at least one pool, wherein the event is contingent on at least one outcome;
an instruction for receiving, at the computing equipment, respective event data from each of a plurality of network entities coupled to the network, wherein each of the respective event data comprises a stake value, a certainty value, and content data associated with the at least one outcome;
an instruction for identifying, by the computing equipment, a subset of network entities to exclude from the event based on at least one of a certainty value and a performance metric;
an instruction for excluding the subset of network entities from the event, with remaining network entities being active network entities in the event;
an instruction for computing, by the computing equipment, a respective estimated allotment for each active network entity based on the at least one pool, a respective stake value, and a respective certainty value;
an instruction for communicating, over the network using the computing equipment, to each of the active network entities the respective estimated allotment;
an instruction for determining, by the computing equipment, outcome data corresponding to the at least one outcome;
in response to receiving the outcome data, an instruction for computing an actual allotment to each respective active network entity based on the at least one pool, the respective stake value, respective content data, at least one multiplier, and the outcome data;
an instruction for generating, using the computing equipment, results data based on the outcome data;
an instruction for communicating over the network, using the computing equipment, the results data to be displayed; and
an instruction for generating a command, using the computing equipment, to allot the actual allotment to each respective active network entity entitled to allotment by causing a respective beneficiary account associated with the active network entities entitled to allotment to receive the respective actual allotment.

78. The non-transient computer readable medium of claim 77, wherein the performance metric comprises at least one of a historical performance metric and a live performance metric.

79. (canceled)

80. The non-transient computer readable medium of claim 77, wherein the instruction for causing the respective beneficiary account associated with the active network entities entitled to allotment to receive the respective actual allotment comprises an instruction for updating a database stored in an immutable distributed network.

81. The non-transient computer readable medium of claim 77, wherein the instruction for identifying the subset further comprises:
an instruction for sorting the data from the plurality of network entities based on certainty values;
an instruction for determining a threshold value based on the certainty values, the at least one pool, and stake values; and
an instruction for identifying the subset based on the threshold value.

82. The non transient computer readable medium of claim 77, wherein the outcome is expected to be available at a future time, and wherein the content data comprises prediction data associated with the at least one outcome.

83. (canceled)

84. (canceled)

85. The non-transient computer readable medium of claim 77, further comprising instructions for determining the multiplier based on at least one of the certainty values.

86. (canceled)

87. (canceled)

88. (canceled)

89. (canceled)

90. The non-transient computer readable medium of claim 77, wherein the network comprises a plurality of nodes that form a sub-network on which an immutable database is distributed, and wherein the instruction for receiving the respective event data comprises an instruction for updating the immutable database to reflect the respective event data.

91. (canceled)

92. (canceled)

93. (canceled)

94. (canceled)

95. (canceled)

96. (canceled)

97. (canceled)

98. (canceled)

99. (canceled)

100. The non-transient computer readable medium of claim 77, further comprising:
an instruction for receiving at least one update to event data from a respective active network entity of the active network entities; and
an instruction for updating the event data based on the update.

101. The non-transient computer readable medium of claim 100, wherein in response to receiving the at least one update, the non-transient computer readable medium further comprises:
an instruction for computing, by the computing equipment, an updated respective estimated allotment for each active network entity based on the update; and
an instruction for communicating, over the network using the computing equipment, to each of the active network entities the respective updated estimated allotment.

102. (canceled)

103. (canceled)

104. (canceled)

105. (canceled)

106. (canceled)

107. (canceled)

108. The non transient computer readable medium of claim 77, wherein the instruction for excluding the subset of network entities further comprises an instruction for generating and communicating an indication of exclusion over the network to at least the subset of network entities.

109. (canceled)

110. (canceled)

111. (canceled)

112. (canceled)

113. (canceled)

114. (canceled)
